(19) United States
(12) Patent Application Publication
(10) Pub. No.: US 2010/0177622 A1
(43) Pub. Date: Jul. 15, 2010

(54) OPTICAL DISK REPRODUCING DEVICE AND OPTICAL DISK REPRODUCING METHOD

(75) Inventors: Ariyoshi Nakaoki, Tokyo (JP); Osamu Kawakubo, Saitama (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/685,881

(22) Filed: Jan. 12, 2010

(30) Foreign Application Priority Data
Jan. 15, 2009 (JP) 2009-006930

(51) Int. Cl. G11B 7/00

(52) U.S. Cl. 369/112.23; 369/121; G9B/7

(57) ABSTRACT

An optical disk reproducing device includes: a semiconductor laser for sequentially emitting singular peak light and singular slope light as laser light when supplied with a driving pulse formed in a form of a pulse and formed of a predetermined singular voltage; an objective lens for condensing the laser light onto a recording layer disposed in an optical disk, and converting an angle of divergence of return light returned from the recording layer; a detection signal generating section configured to detect respective light intensities in each of wavelength bands in the return light, and respectively generate a plurality of detection signals according to the respective light intensities; and a reproduction processing section configured to reproduce information recorded on the optical disk on a basis of the plurality of detection signals.

### BACKGROUND OF THE INVENTION

1. Field of the Invention

The present invention relates to an optical disk reproducing device and an optical disk reproducing method, and is suitable for application to an optical disk reproducing device for reproducing information from an optical disk, for example.

2. Description of the Related Art

Until now, optical disk reproducing devices have been spread widely which read information from optical disks such as a CD (Compact Disc), a DVD (Digital Versatile Disc), and a Blu-ray Disc (registered trademark) (the Blu-ray Disc will hereinafter be referred to as a BD) as optical information recording media.

Such an optical disk reproducing device stores various contents such as music contents, video contents and the like or various information such as various data for a computer and the like on an optical disk.

Because an amount of information has been increased due to higher definitions of video, higher sound quality of music, or the like, there has particularly been a desire for a further increase in the capacity of the optical disk.

Accordingly, as a method for increasing the capacity of such an optical disk, a method has been proposed which forms a combination of a plurality of kinds of recording marks in a recording layer of the optical disk and which multiplexes and modulates a signal in each wavelength band in return light produced when the optical disk is irradiated with a light beam. In the case of this method, the optical disk reproducing device detects signals from a plurality of frequency bands, respectively, in the return light obtained from the optical disk, and reproduces information on the basis of the signals (see for example ISOM/ODS '08 WA02 TD05-31 “Plasmonic Nano-Structure for Optical Data Storage”).

### SUMMARY OF THE INVENTION

The above-described optical disk reproducing device irradiates the optical disk with a light beam in the form of a pulse, and needs to use a so-called picosecond laser or a so-called femtosecond laser as a light source of the light beam.

Generally, a picosecond laser or a femtosecond laser has a relatively large constitution. Accordingly, the optical disk reproducing device has a large device constitution, and is difficult to miniaturize to such a degree as to be tolerable for use within a house or for mobile use.

The present invention has been made in view of the above points. It is desirable to propose an optical disk reproducing device and an optical disk reproducing method that make it possible to increase the capacity of the optical disk and miniaturize the device constitution.

According to an embodiment of the present invention, there is provided an optical disk reproducing device including: a semiconductor laser for sequentially emitting singular peak light having a light intensity characteristic in a form of a pulse and having a singular peak wavelength and singular slope light having a light intensity characteristic in a form of a slope of lower light intensity than the singular peak light and having a singular slope wavelength different from the singular peak wavelength as laser light when supplied with a driving pulse formed in a form of a pulse and formed of a predetermined singular voltage; an objective lens for condensing the laser light onto a recording layer disposed in an optical disk, a plurality of kinds of recording marks being formed in the recording layer, and converting an angle of divergence of return light, the return light having a light intensity modulated in each of a plurality of wavelength bands independently and being returned from the recording layer; a detection signal generating section configured to detect respective light intensities in each of the wavelength bands in the return light, and respectively generate a plurality of detection signals according to the respective light intensities; and a reproduction processing section configured to reproduce information recorded on the optical disk on a basis of the plurality of detection signals.

Thereby, the optical disk reproducing device according to the above-described embodiment of the present invention can irradiate the recording layer of the optical disk with a light beam of a very short pulse width using the semiconductor laser that can be formed in a relatively small size, and obtain a detection signal in each of the wavelength bands on the basis of the return light from the recording layer and reproduce information.

According to an embodiment of the present invention, there is provided an optical disk reproducing method including the steps of: sequentially emitting singular peak light having a light intensity characteristic in a form of a pulse and having a singular peak wavelength and singular slope light having a light intensity characteristic in a form of a slope of lower light intensity than the singular peak light and having a singular slope wavelength different from the singular peak wavelength as laser light from a predetermined semiconductor laser when the semiconductor laser is supplied with a driving pulse formed in a form of a pulse and formed of a predetermined singular voltage; condensing the laser light onto a recording layer disposed in an optical disk, a plurality of kinds of recording marks being formed in the recording layer, by a predetermined objective lens; converting an angle of divergence of return light by the objective lens, the return light including a plurality of wavelengths, having a light intensity modulated at each of the wavelengths independently, and being returned from the recording layer; detecting respective light intensities at each of the wavelengths in the return light, and respectively generating a plurality of detection signals according to the respective light intensities; and reproducing information recorded on the optical disk on a basis of the plurality of detection signals.

Thereby, the optical disk reproducing method according to the above-described embodiment of the present invention can irradiate the recording layer of the optical disk with a light beam of a very short pulse width using the semiconductor laser that can be formed in a relatively small size, and obtain a detection signal in each of the wavelength bands on the basis of the return light from the recording layer and reproduce information.

According to the present invention, it is possible to irradiate the recording layer of the optical disk with a light beam of a very short pulse width using the semiconductor laser that can be formed in a relatively small size, and obtain a detection signal in each of the wavelength bands on the basis of the return light from the recording layer and reproduce information. Thus, the present invention can realize an optical disk reproducing device and an optical disk reproducing method that make it possible to increase the capacity of the optical disk and miniaturize device constitution.

### BRIEF DESCRIPTION OF THE DRAWINGS

FIG. 1 is a schematic diagram showing a constitution of a short pulse light source device;

FIGS. 2A, 2B, and 2C are schematic diagrams showing a pulse signal and a laser driving signal;

FIG. 3 is a schematic diagram of assistance in explaining a relation (1) between injected carrier density and photon density;

FIG. 4 is a schematic diagram of assistance in explaining a relation between injected carrier density and carrier density;

FIG. 5 is a schematic diagram of assistance in explaining a relation (2) between injected carrier density and photon density;

FIG. 6 is a schematic diagram of assistance in explaining photon density at a point PT1;

FIG. 7 is a schematic diagram of assistance in explaining photon density at a point PT2;

FIG. 8 is a schematic diagram of assistance in explaining photon density at a point PT3;

FIG. 9 is a schematic diagram showing an actual light emission waveform;

FIGS. 10A, 10B, 10C, 10D, and 10E are schematic diagrams showing relation between a driving signal and light intensity;

FIG. 11 is a schematic diagram showing a constitution of a light measuring device;

FIGS. 12A, 12B, and 12C are schematic diagrams showing the shapes of respective pulses;

FIG. 13 is a schematic diagram showing relation between a pulse signal and a driving pulse;

FIGS. 14A and 14B are schematic diagrams showing light intensity characteristics when the voltage of the driving pulse is changed;

FIGS. 15A and 15B are schematic diagrams showing a wavelength characteristic and a light intensity characteristic when the voltage of the driving pulse is 8.8 [V];

FIGS. 16A and 16B are schematic diagrams showing a wavelength characteristic and a light intensity characteristic when the voltage of the driving pulse is 13.2 [V];

FIGS. 17A and 17B are schematic diagrams showing a wavelength characteristic and a light intensity characteristic when the voltage of the driving pulse is 15.6 [V];

FIGS. 18A and 18B are schematic diagrams showing a wavelength characteristic and a light intensity characteristic when the voltage of the driving pulse is 17.8 [V];

FIGS. 19A and 19B are schematic diagrams showing a wavelength characteristic and a light intensity characteristic when the voltage of the driving pulse is 38.4 [V];

FIG. 20 is a schematic diagram showing a difference between light intensity characteristics with and without a BPF;

FIGS. 21A and 21B are schematic diagrams showing a difference between wavelength characteristics with and without a BPF;

FIG. 22 is a schematic diagram showing the light intensity characteristic of singular output light;

FIG. 23 is a schematic diagram showing a constitution of recording marks in the recording layer of an optical disk;

FIGS. 24A, 24B, and 24C are schematic diagrams showing spectra of return light beams;

FIG. 25 is a schematic diagram showing a constitution of an optical disk reproducing device;

FIG. 26 is a schematic diagram showing a constitution of an optical pickup in a first embodiment;

FIG. 27 is a schematic diagram showing a constitution of an optical pickup in a second embodiment; and

FIG. 28 is a schematic diagram showing a constitution of an optical pickup in a third embodiment.

### DETAILED DESCRIPTION OF THE PREFERRED EMBODIMENTS

A mode for carrying out the invention (hereinafter referred to as embodiments) will hereinafter be described with reference to the drawings. Incidentally, description will be made in the following order.

1. Operating Principles of Semiconductor Laser

2. First Embodiment (Example of Spectrum Analysis)

3. Second Embodiment (Example of Separating Return Light by Wavelength)

4. Third Embodiment (Example of Separating Detection Signal by Time)

5. Other Embodiments

### 1. Operating Principles of Semiconductor Laser

### [1-1. Constitution of Short Pulse Light Source Device]

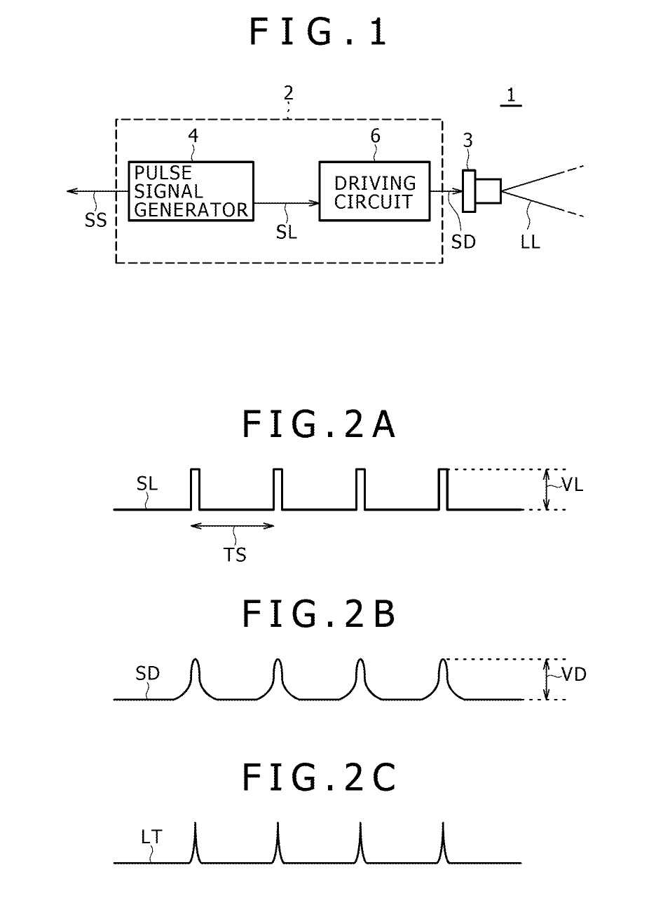

FIG. 1 shows a general constitution of a short pulse light source device 1 according to a present embodiment. This short pulse light source device 1 includes a laser controlling section 2 and a semiconductor laser 3.

The semiconductor laser 3 is formed by an ordinary semiconductor laser using semiconductor light emission (for example an SLD3233 manufactured by Sony Corporation). The laser controlling section 2 controls a driving signal SD supplied to the semiconductor laser 3 to thereby make pulse-shaped laser light LL output from the semiconductor laser 3.

The laser controlling section 2 includes a pulse signal generator 4 for generating a plurality of kinds of pulse-shaped signals in predetermined timing and a driving circuit 6 for driving the semiconductor laser 3.

The pulse signal generator 4 generates a synchronizing signal SS formed by a rectangular wave having a predetermined cycle TS within the pulse signal generator 4. The pulse signal generator 4 operates in timing based on the synchronizing signal SS, and is able to supply the synchronizing signal SS to an external measuring device (not shown) or the like.

In addition, as shown in FIG. 2A, the pulse signal generator 4 generates a pulse signal SL changing in the form of a pulse in each cycle TS, and supplies the pulse signal SL to the driving circuit 6. This pulse signal SL indicates, to the driving circuit 6, timing and a period when power is to be supplied to the semiconductor laser 3 and the magnitude of a voltage level.

The driving circuit 6 generates a laser driving signal SD as shown in FIG. 2B on the basis of the pulse signal SL, and supplies the laser driving signal SD to the semiconductor laser 3.

At this time, the driving circuit 6 generates the laser driving signal SD by amplifying the pulse signal SL by a predetermined amplification factor. The peak voltage VD of the laser driving signal SD thus changes according to the peak voltage VL of the pulse signal SL. Incidentally, the waveform of the laser driving signal SD is distorted due to the amplification characteristic of the driving circuit 6.

The driving circuit 6 is configured to generate the laser driving signal SD by amplifying the pulse signal SL by a predetermined amplification factor also when supplied with the pulse signal SL externally.

When supplied with the laser driving signal SD, as shown in FIG. 2C, the semiconductor laser 3 emits laser light LL while changing light intensity LT of the laser light LL in the form of pulses. To emit laser light in the form of a pulse will hereinafter be written as to “pulse-output” laser light.

Thus, the short pulse light source device 1 directly pulse-outputs the laser light LL from the semiconductor laser 3 by the control of the laser controlling section 2 without using other optical parts or the like.

### [1-2. Pulse Output of Laser Light in Relaxation Oscillation Mode]

It is generally known that characteristics of a laser are expressed by a so-called rate equation. For example, the rate equation is expressed as in the following Equation (1) using a confinement factor ΓF, a photon lifetime τₚₕ [s], a carrier lifetime τₛ [s], a spontaneous emission coupling factor Cₛ, an active layer thickness d [mm], an elementary charge q [C], a maximum gain gₘₐₓ, a carrier density N, a photon density S, an injected carrier density J, the speed of light c [m/s], a transparency carrier density N₀, a group index of refraction n_{g}, and an area A_{g}.

$$\begin{matrix}[ Equation 1 ] & \\ \frac{d N}{d t} = \text{?} \text{?} GS \text{?} \frac{N}{τ \text{?}} \text{?} \frac{J}{dq} \\ \text{?} \text{indicates text missing or illegible when filed} & [ 1 ]\end{matrix}$$

wherein

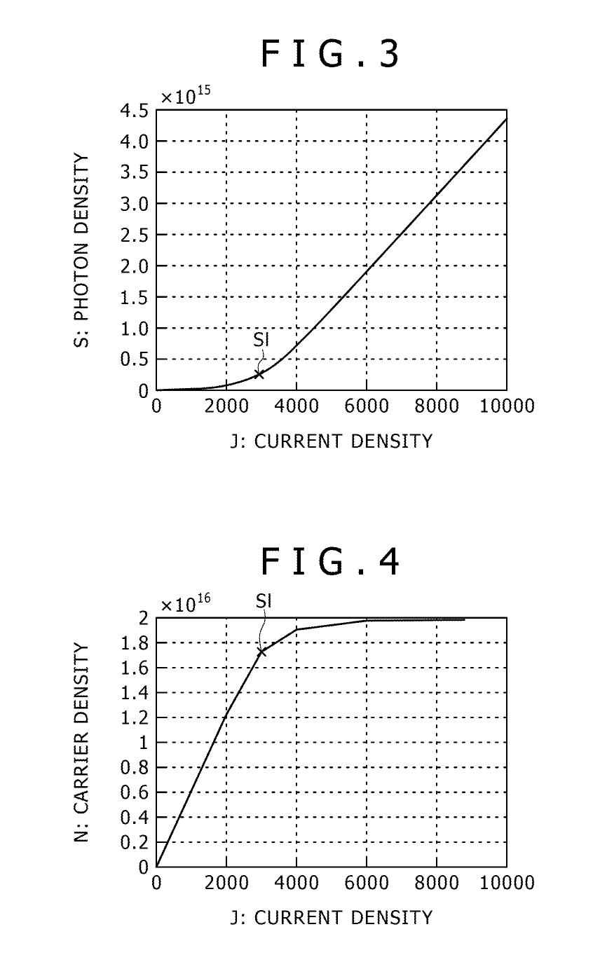

Next, a result of calculating relation between the injected carrier density J and the photon density S on the basis of the rate equation of Equation (1) is shown in a graph of FIG. 3, and a result of calculating relation between the injected carrier density J and the carrier density N on the basis of the rate equation of Equation (1) is shown in a graph of FIG. 4.

Incidentally, these calculation results are obtained when the confinement factor Γ=0.3, the photon lifetime τₚₕ=1e⁻¹² [s], the carrier lifetime Tₛ=1e⁻⁹ [s], the spontaneous emission coupling factor Cs=0.03, the active layer thickness d=0.1 [μm], the elementary charge q=1.6e⁻¹⁹ [C], and the area A_{g}=3e⁻¹⁶ [cm²].

As shown in FIG. 4, an ordinary semiconductor layer starts emitting light at a pre-saturation point S1 a little before a saturated state of the carrier density N in response to increase in the injected carrier density J (that is, the laser driving signal SD).

In addition, as shown in FIG. 3, the semiconductor laser increases the photon density S (that is, light intensity) with increase in the injected carrier density J. Further, FIG. 5 corresponding to FIG. 3 shows that the semiconductor laser further increases the photon density S with further increase in the injected carrier density J.

Next, a point PT1 at which the injected carrier density J is relatively high and points PT2 and PT3 at which the injected carrier density J is sequentially decreased from the point PT1 are each selected on a characteristic curve shown in FIG. 5.

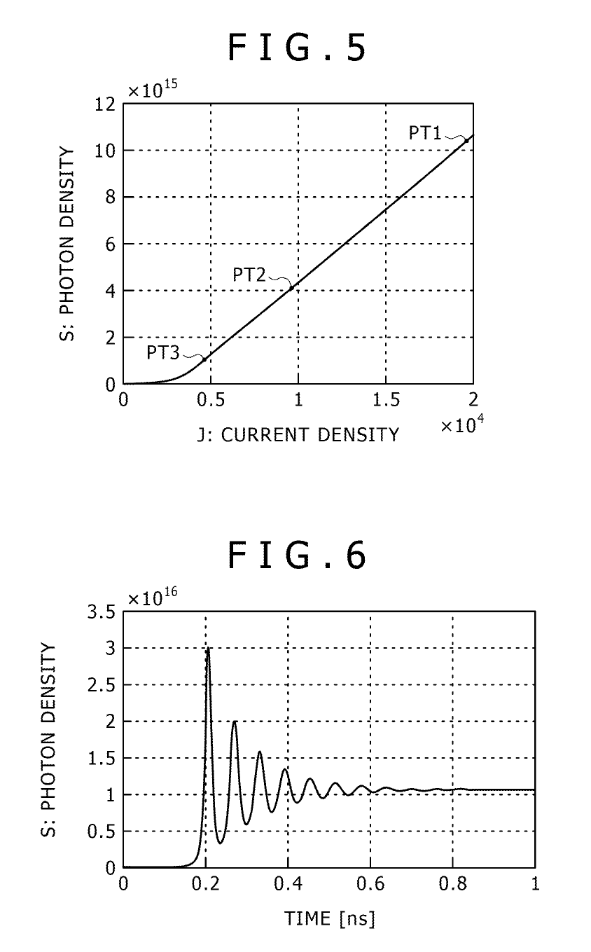

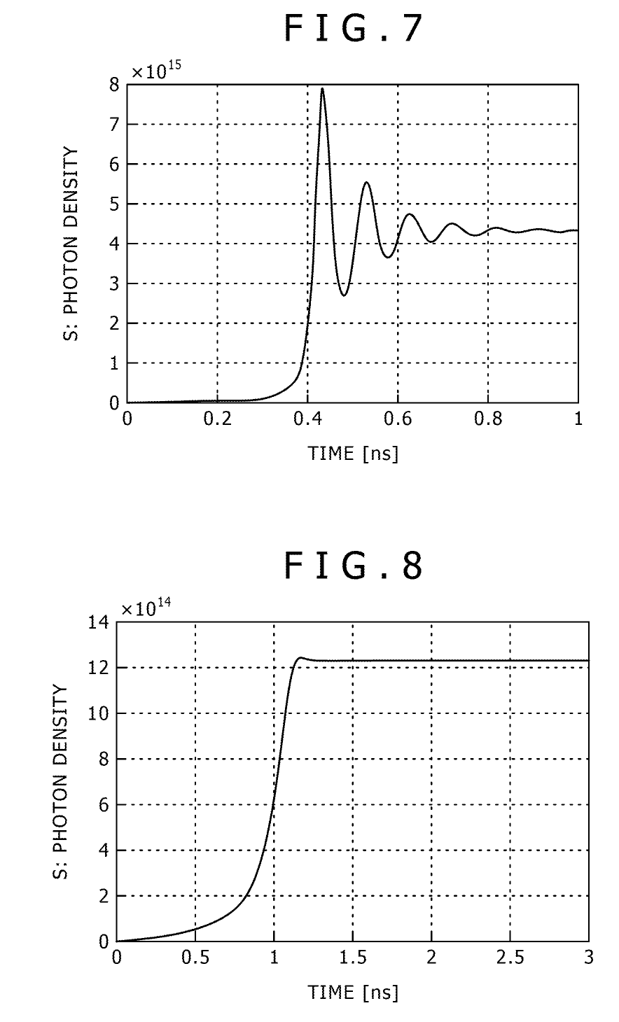

Results of calculating the photon density S changing from a start of application of the laser driving signal SD at the points PT1, PT2, and PT3 are shown in FIG. 6, FIG. 7, and FIG. 8, respectively. Incidentally, the magnitude of the injected carrier density J corresponds to the magnitude of the laser driving signal SD supplied to the semiconductor laser, and the magnitude of the photon density S corresponds to the magnitude of light intensity.

As shown in FIG. 6, it is confirmed that the photon density S at the point PT1 increases the amplitude thereof by greatly oscillating by so-called relaxation oscillation and that the photon density S at the point PT1 has a small oscillation cycle to of about 60 [ps], which is the cycle of the amplitude (that is, from a minimum value to a minimum value). In addition, as for the value of the photon density S, a first wave appearing immediately after light emission has a highest amplitude, a second wave and a third wave are gradually attenuated, and then the value of the photon density S eventually becomes stable.

The maximum value of the first wave of the photon density S at the point PT1 is about 3×10¹⁶, which is about three times a stable value (about 1×10¹⁶) when the photon density S becomes stable.

Letting a time from a start of application of the laser driving signal SD to a start of light emission be an emission start time τd, the emission start time τd can be calculated from the rate equation shown in Equation (1).

That is, supposing that the photon density S=0 before oscillation, the upper equation of Equation (1) can be expressed as follows.

[Equation 2]

[symbol]

(2)

Supposing that the carrier density N is a threshold value Nₜₕ, the emission start time τd can be expressed as by the following equation.

$$\begin{matrix}[ Equation 3 ] & \\ τ d = τ \text{?} {N}_{th } \frac{{J}_{th}}{J} \\ wherein \\ {J}_{th} - \frac{dq}{{τ}_{s}} {N}_{th} \\ \text{?} \text{indicates text missing or illegible when filed} & ( 3 )\end{matrix}$$

It is thus shown that the emission start time τd is inversely proportional to the injected carrier density J.

As shown in FIG. 6, the emission start time τd at the point PT1 is calculated at about 200 [ps] from Equation (3). At this point PT1, the laser driving signal SD of a high voltage value is applied to the semiconductor laser, and thus the emission start time τd from a start of application of the laser driving signal SD to a start of light emission is short.

As shown in FIG. 7, at the point PT2 at which the value of the laser driving signal SD is lower than at the point PT1, clear relaxation oscillation occurs, but the amplitude of the oscillation is reduced as compared with the point PT1 and the oscillation cycle to is increased to about 100 [ps].

In the case of the point PT2, the emission start time id calculated from Equation (3) is about 400 [ps], which is increased as compared with the point PT1. The maximum value of the first wave of the photon density S at the point PT2 is about 8×10¹⁵, which is about twice a stable value (about 4×10¹⁵).

As shown in FIG. 8, at the point PT3 at which the value of the laser driving signal SD is even lower than the point PT2, relaxation oscillation is hardly observed. It is also confirmed that in the case of the point PT3, the emission start time τd calculated from Equation (3) is about 1 [ns], which is relatively long. The maximum value of the photon density S at the point PT3 is substantially the same as a stable value, which is about 1.2×10¹⁵.

An ordinary laser light source applies the laser driving signal SD of a relatively low voltage that hardly effects relaxation oscillation as at the point PT3 to the semiconductor laser. That is, an ordinary laser light source stabilizes the output of laser light LL by controlling the variation width of light intensity to a small width immediately after a start of emission of the laser light.

An operation mode in which the short pulse light source device 1 outputs laser light LL of stable light intensity without causing relaxation oscillation by supplying the laser driving signal SD of a relatively low voltage to the semiconductor laser 3 will hereinafter be referred to as an ordinary mode. The value of the laser driving signal SD supplied to the semiconductor laser 3 in this ordinary mode will be referred to as an ordinary voltage VN, and the laser light LL output from the semiconductor laser 3 in the ordinary mode will be referred to as ordinary output light LN.

In addition, the short pulse light source device 1 according to the present embodiment has an operation mode in which relaxation oscillation is produced in light intensity characteristics by supplying the laser driving signal SD of a relatively high voltage as at the points PT1 and PT2 (which mode will hereinafter be referred to as a relaxation oscillation mode).

In this relaxation oscillation mode, the short pulse light source device 1 raises the voltage V of the laser driving signal SD (which voltage will hereinafter be referred to as an oscillation voltage VB) from the ordinary voltage VN (by a factor of 1.5 or more, for example). As a result, the short pulse light source device 1 can increase the instantaneous maximum value of light intensity LT of the laser light as compared with the ordinary mode.

That is, when operating in the relaxation oscillation mode, by supplying a relatively high oscillation voltage VB to the semiconductor laser 3, the short pulse light source device 1 can emit laser light LL of high light intensity corresponding to the oscillation voltage VB.

When this is viewed from another viewpoint, by being supplied with the laser driving signal SD of the oscillation voltage VB, the semiconductor laser 3 can greatly increase the light intensity of the laser light LL as compared with an existing semiconductor laser to which the ordinary voltage VN is applied.

For example, the photon density S of the semiconductor laser which density is obtained by the first wave of relaxation oscillation at the point PT1 is about 3×10¹⁶. Thus the light intensity of the semiconductor laser 3 can be increased by a factor of 20 or more as compared with the case of the point PT3 (about 1.2×10¹⁵) which case represents the case of the ordinary voltage VN being applied.

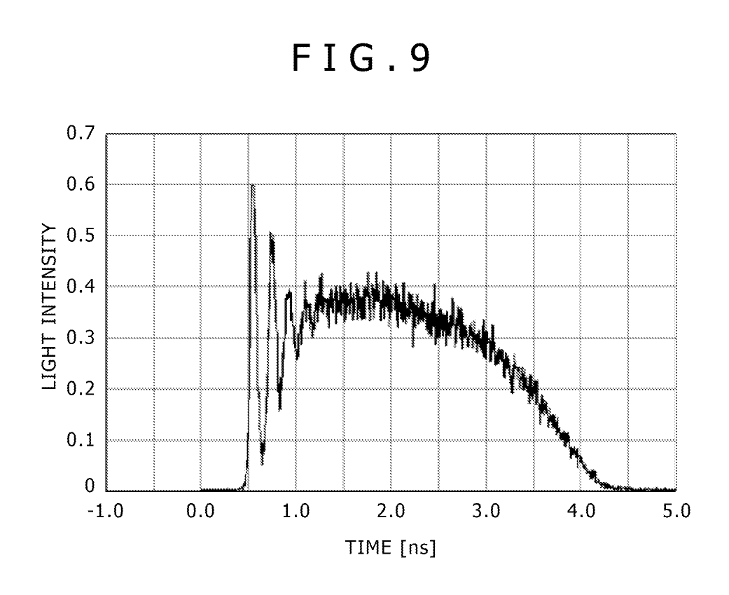

FIG. 9 shows the waveform of a light intensity characteristic measured when the laser driving signal SD of a relatively high voltage is actually applied to an ordinary semiconductor laser (SLD3233VF manufactured by Sony Corporation). Incidentally, FIG. 9 shows the waveform of a light intensity characteristic of laser light LL obtained as a result of applying a rectangular pulse-shaped laser driving signal SD to the semiconductor laser.

It is confirmed from FIG. 9 that relaxation oscillation observed as a result of calculation of the photon density S in FIG. 6 and FIG. 7 occurs also as changes in actual light intensity.

Relation between the laser driving signal SD supplied to the semiconductor laser 3 and the light intensity of the laser light LL will be discussed below in detail.

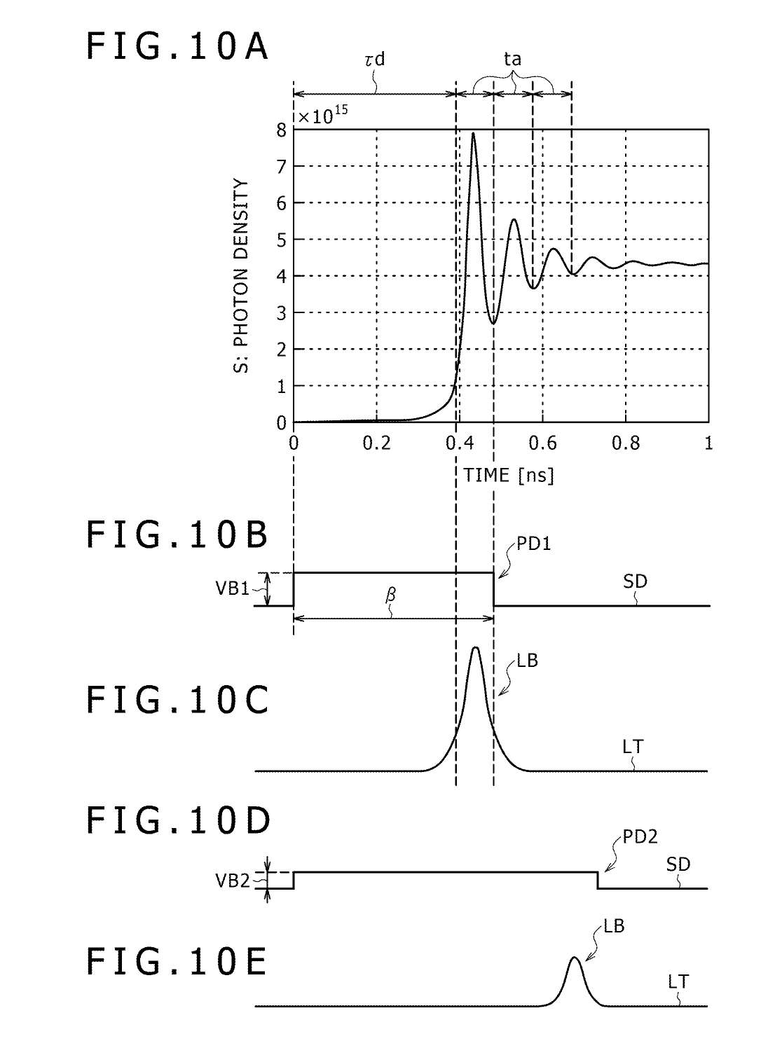

FIG. 10A shows temporal changes in the photon density S as with FIG. 7. As shown in FIG. 10B, for example, the laser controlling section 2 of the short pulse light source device 1 supplies the semiconductor laser 3 with a pulse-shaped laser driving signal SD of a sufficient oscillation voltage VB1 to produce relaxation oscillation.

At this time, the laser controlling section 2 makes the laser driving signal SD a rectangular pulse signal by raising the laser driving signal SD from a low level to a high level over a time obtained by adding the oscillation cycle ta of relaxation oscillation to the emission start time τd (that is, τd+ta, which will hereinafter be referred to as a supply time TPD).

Incidentally, for convenience of description, the part of the laser driving signal SD which part is raised in the form of a pulse will be referred to as a driving pulse PD1.

As a result, as shown in FIG. 10C, the semiconductor laser 3 can emit pulse-shaped laser light LL (which will hereinafter be referred to as oscillation output light LB) corresponding to only the part of the first wave in relaxation oscillation.

At this time, because the laser controlling section 2 supplies the pulse-shaped driving pulse PD, the time of application of the high oscillation voltage VB can be controlled to a relatively short time. It is therefore possible to lower the average power consumption of the semiconductor laser 3 and prevent a defect or destruction of the semiconductor laser 3 due to excessive heat generation or the like.

On the other hand, as shown in FIG. 10D, the laser controlling section 2 can supply the semiconductor laser 3 with a driving pulse PD2 of an oscillation voltage VB2 so high as to be able to produce relaxation oscillation and lower than the oscillation voltage VB1.

In this case, as shown in FIG. 10E, the semiconductor laser 3 can emit oscillation output light LB of low light intensity as compared with the case where the driving pulse PD1 is supplied.

The short pulse light source device 1 can thus operate in the relaxation oscillation mode in which the driving pulse PD (that is, the driving pulse PD1 or PD2) of a relatively high oscillation voltage VB is supplied from the laser controlling section 2 to the semiconductor laser 3. At this time, the short pulse light source device 1 can emit oscillation output light LB whose light intensity is changed in the form of pulses by relaxation oscillation.

### [1-3. Pulse Output of Laser Light in Singular Mode]

Further, in addition to the ordinary mode and the relaxation oscillation mode, the short pulse light source device 1 is configured to operate in a singular mode in which a driving pulse PD of a singular voltage VE higher than the oscillation voltage VB is supplied to the semiconductor laser 3.

At this time, the short pulse light source device 1 can pulse-output laser light LL of even higher light intensity than that of the oscillation output light LB from the semiconductor laser 3.

### [1-3-1. Constitution of Light Measuring Device]

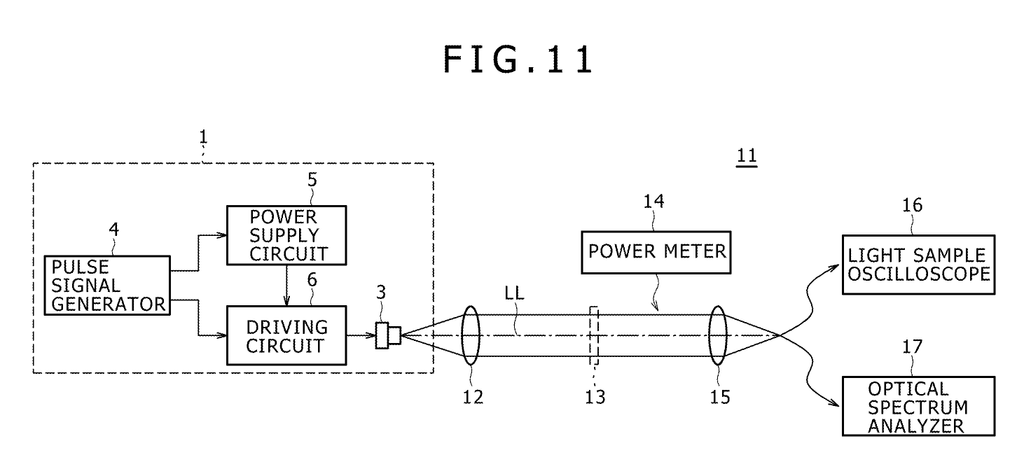

An experiment for measuring the light intensity of laser light LL when the voltage V of the driving pulse PD in the short pulse light source device 1 is changed was performed by using a light measuring device 11 (FIG. 11) for measuring and analyzing the laser light LL emitted from the short pulse light source device 1.

The light measuring device 11 makes the laser light LL emitted from the semiconductor laser 3 of the short pulse light source device 1, and makes the laser light LL enter a collimator lens 12.

Next, the light measuring device 11 converts the laser light LL from diverging light to collimated light by the collimator lens 12, makes the laser light LL enter a condensing lens 15, and further condenses the laser light LL by the condensing lens 15.

The light measuring device 11 thereafter supplies the laser light LL to a light sample oscilloscope 16 (C8188-01 manufactured by Hamamatsu Photonics). The light measuring device 11 thereby measures the light intensity of the laser light LL and shows temporal changes in the light intensity of the laser light LL as a light intensity characteristic UT (to be described later).

In addition, the light measuring device 11 supplies the laser light LL to an optical spectrum analyzer 17 (Q8341 manufactured by ADC Corporation). The light measuring device 11 thereby analyzes the wavelength of the laser light LL and shows the distribution characteristic thereof as a wavelength characteristic UW (to be described later).

The light measuring device 11 also has a power meter 14 (Q8230 manufactured by ADC Corporation) installed between the collimator lens 12 and the condensing lens 15. The light measuring device 11 measures the light intensity LT of the laser light LL by the power meter 14.

Further, the light measuring device 11 allows a BPF (Band Pass Filter) 13 to be installed between the collimator lens 12 and the condensing lens 15 as required. This BPF 13 can reduce the transmittance of a specific wavelength component in the laser light LL.

### [1-3-2. Relation Between Set Pulse and Driving Pulse]

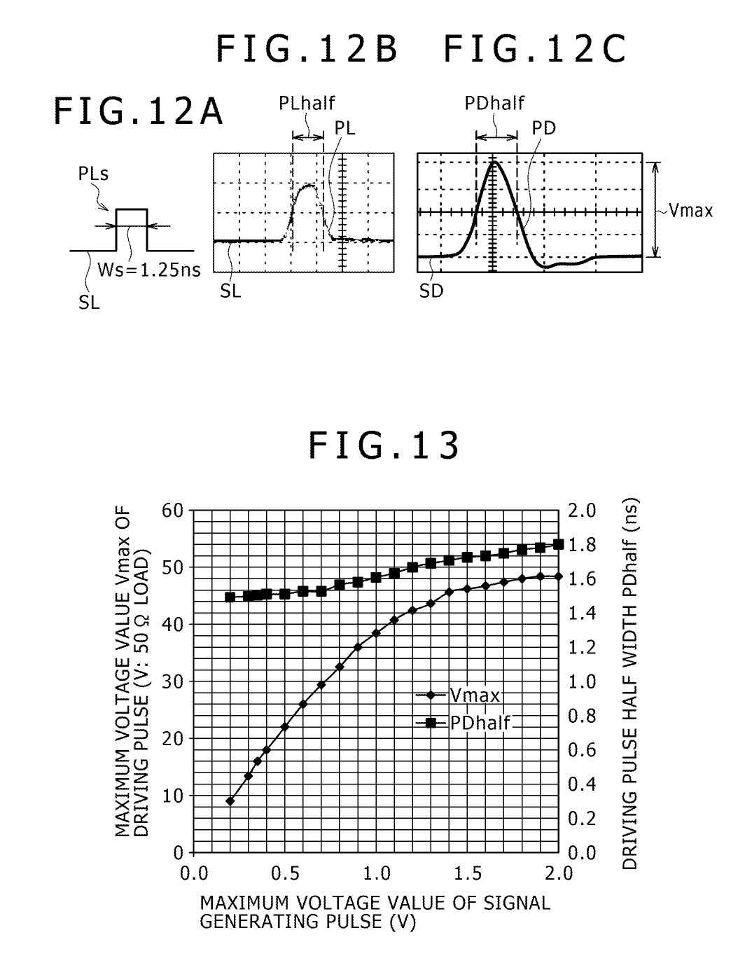

The pulse signal SL, the laser driving signal SD or the like actually generated in the short pulse light source device 1 is a so-called high-frequency signal. Therefore the waveform of each signal is expected to be a so-called “blunt” waveform deformed from an ideal rectangular wave. Accordingly, as shown in FIG. 12A, the pulse signal generator 4 is set to output a pulse signal SL including a rectangular set pulse PLs having a pulse width Ws of 1.5 [ns]. A measurement result as shown in FIG. 12B was obtained when the pulse signal SL was measured by a predetermined measuring device.

A generated signal pulse half width PLhalf, which is a half width of a pulse (which pulse will hereinafter be referred to as a generated pulse PL) generated in correspondence with the set pulse PLs in the pulse signal SL of FIG. 12B, is about 1.5 [ns].

In addition, a measurement result as shown in FIG. 12C was obtained when the laser driving signal SD actually supplied from the driving circuit 6 to the semiconductor laser 3 at a time of supplying the above-described pulse signal SL from the pulse signal generator 4 to the driving circuit 6 was similarly measured.

A driving pulse half width PDhalf, which is a half width of a pulse (that is, the driving pulse PD) appearing in correspondence with the generated pulse PL in the laser driving signal SD, changes in a range of about 1.5 [ns] to about 1.7 [ns] according to the signal level of the generated pulse PL.

Relation of the voltage pulse half width PDhalf of the driving pulse PD to the maximum voltage value of the generated pulse PL at this time and relation of the maximum voltage value Vmax of the driving pulse PD to the maximum voltage value of the generated pulse PL are both shown in FIG. 13.

FIG. 13 shows that as the maximum voltage value of the generated pulse PL supplied to the driving circuit 6 is increased, the maximum voltage value Vmax of the driving pulse PD in the laser driving signal SD output from the driving circuit 6 is also increased.

In addition, FIG. 13 shows that as the maximum voltage value of the generated pulse PL supplied to the driving circuit 6 is increased, the driving pulse half width PDhalf of the driving pulse PD is also increased gradually.

In other words, even when the short pulse light source device 1 sets the generated pulse PL of a fixed pulse width in the pulse signal generator 4, the short pulse light source device 1 can change the pulse width and the voltage value of the driving pulse PD in the laser driving signal SD output from the driving circuit 6 by changing the maximum voltage value of the generated pulse PL supplied to the driving circuit 6.

### [1-3-3. Relation Between Voltage of Driving Pulse and Output Laser Light]

Accordingly, the light intensities of the laser light LL output from the semiconductor laser 3 according to the driving pulse PD when the maximum voltage value Vmax of the driving pulse PD was set to various values were each measured by the light sample oscilloscope 16 of the light measuring device 11 (FIG. 11).

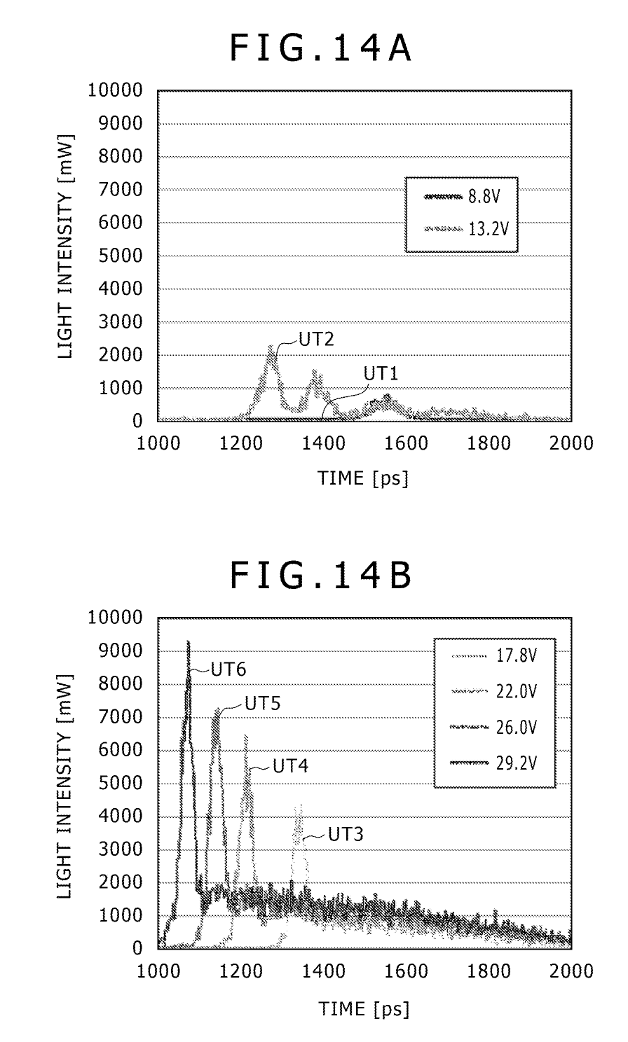

FIGS. 14A and 14B show results of this measurement. Incidentally, in FIGS. 14A and 14B, a time axis (axis of abscissas) indicates relative time, and does not indicate absolute time. In addition, the BPF 13 is not installed in this measurement.

As shown in FIG. 14A, when the maximum voltage value Vmax of the driving pulse PD is 8.8 [V], a light intensity characteristic UT1 of the laser light LL has only one small output peak (in the vicinity of time 1550 [ps]) with a relatively large width, and does not exhibit oscillation due to relaxation oscillation. That is, the light intensity characteristic UT1 indicates that the short pulse light source device 1 operates in the ordinary mode and outputs ordinary output light LN from the semiconductor laser 3.

In addition, as shown in FIG. 14A, when the maximum voltage value Vmax of the driving pulse PD is 13.2 [V], a light intensity characteristic UT2 of the laser light LL has a plurality of peaks due to relaxation oscillation. That is, the light intensity characteristic UT2 indicates that the short pulse light source device 1 operates in the relaxation oscillation mode and outputs oscillation output light LB from the semiconductor laser 3.

On the other hand, as shown in FIG. 14B, when the maximum voltage value Vmax of the driving pulse PD is 17.8 [V], 22.0 [V], 26.0 [V], and 29.2 [V], light intensity characteristics UT3, UT4, UT5, and UT6 of the laser light LL have a peak part appearing as a first peak at a relatively early time and a subsequent slope part gently attenuated with small oscillation.

The light intensity characteristics UT3, UT4, UT5, and UT6 do not exhibit a high peak after the first peak part, and thus have a clearly different waveform tendency as compared with the light intensity characteristic UT2 (FIG. 14A) in the relaxation oscillation mode having the peaks of a second wave and a third wave following a first wave.

Incidentally, though not shown in FIG. 14A or 14B because the resolution of the light sample oscilloscope 16 in the light measuring device 11 is about 30 [ps] or more, the peak width (half width) of the first peak part was confirmed to be about 10 [ps] by a separate experiment using a streak camera.

Because the resolution of the light sample oscilloscope 16 is thus low, the light measuring device 11 may not necessarily be able to measure correct light intensity LT. In this case, the maximum light intensity of the first peak part in FIGS. 14A and 14B and the like is shown to be lower than an actual value.

Next, the laser light LL when the maximum voltage value Vmax of the driving pulse PD is changed will be analyzed in further detail.

In this case, using the light measuring device 11, the light intensity characteristic UT and the wavelength characteristic UW of the laser light LL emitted from the semiconductor laser 3 when the maximum voltage value Vmax of the driving pulse PD was changed were measured by the light sample oscilloscope 16 and the optical spectrum analyzer 17, respectively.

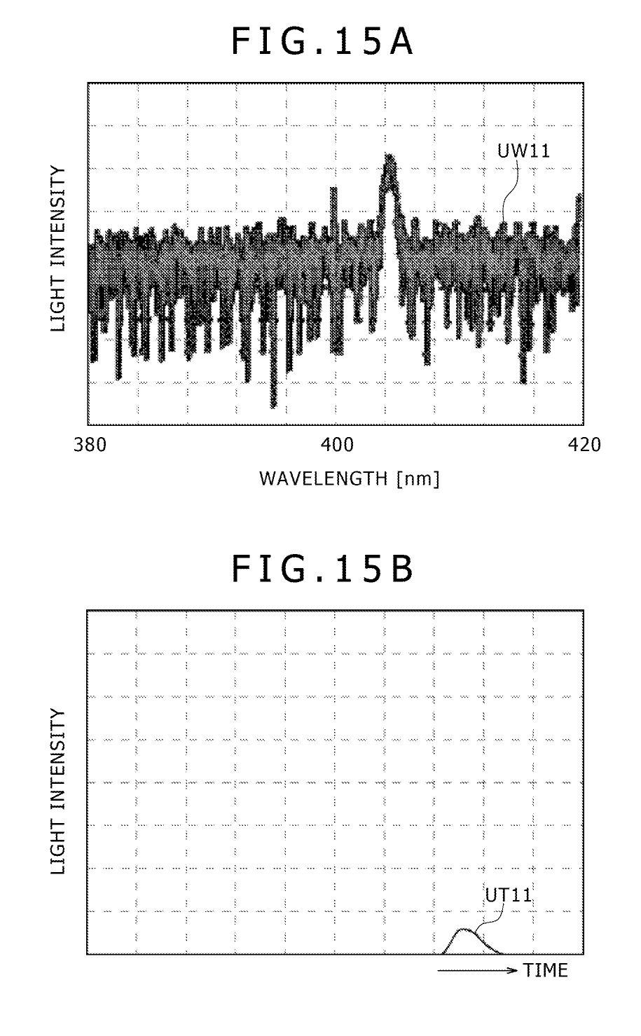

FIGS. 15A to 19B each show a result of this measurement. Incidentally, FIGS. 15A, 16A, 17A, 18A and 19A show the wavelength characteristic UW of the laser light LL (that is, a result of resolving the laser light LL by wavelength) measured by the optical spectrum analyzer 17. FIGS. 15B, 16B, 17B, 18B and 19B show the light intensity characteristic UT (that is, temporal changes) of the laser light LL measured by the light sample oscilloscope 16, as with FIGS. 14A and 14B. The BPF 13 is not installed in this measurement.

As shown in FIG. 15B, when the maximum voltage value Vmax of the driving pulse PD is 8.8 [V], the waveform of a light intensity characteristic UT11 of the laser light LL has only one peak. It can be said from this that the short pulse light source device 1 at this time operates in the ordinary mode and that the laser light LL is ordinary output light LN.

In addition, as shown in FIG. 15A, the wavelength characteristic UW11 at this time has only one peak at a wavelength of about 404 [nm]. This indicates that the wavelength of the laser light LL is about 404 [nm].

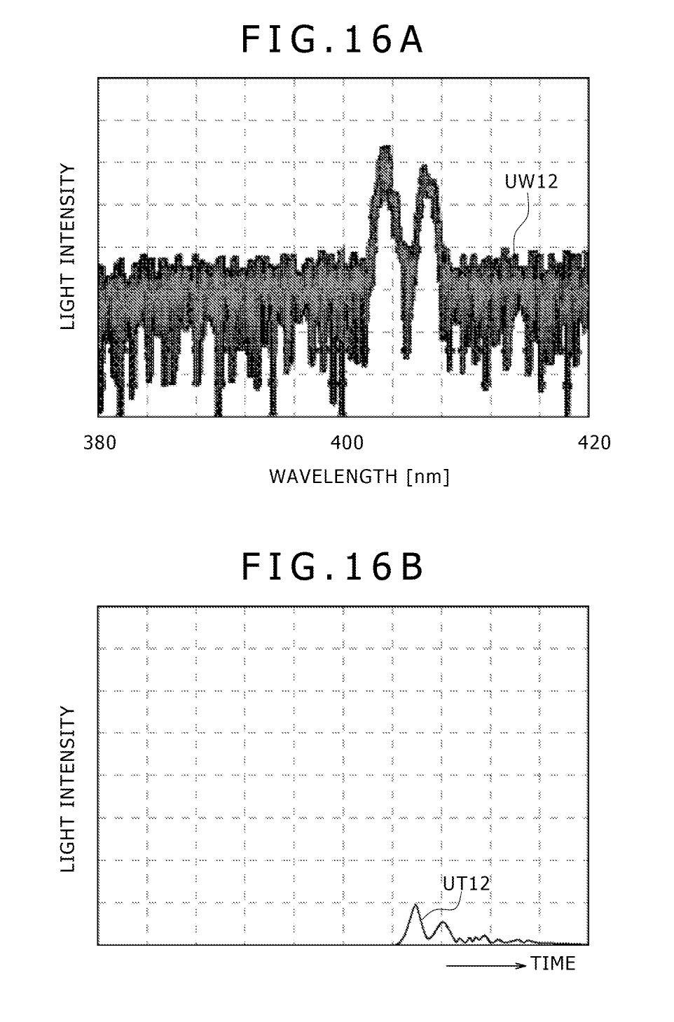

As shown in FIG. 16B, when the maximum voltage value Vmax of the driving pulse PD is 13.2 [V], a light intensity characteristic UT12 of the laser light LL has a plurality of relatively high peaks. It can be said from this that the short pulse light source device 1 at this time operates in the relaxation oscillation mode and that the laser light LL is oscillation output light LB.

In addition, as shown in FIG. 16A, the wavelength characteristic UW12 at this time has two peaks at wavelengths of about 404 [nm] and about 407 [nm]. This indicates that the wavelength of the laser light LL is about 404 [nm] and about 407 [nm].

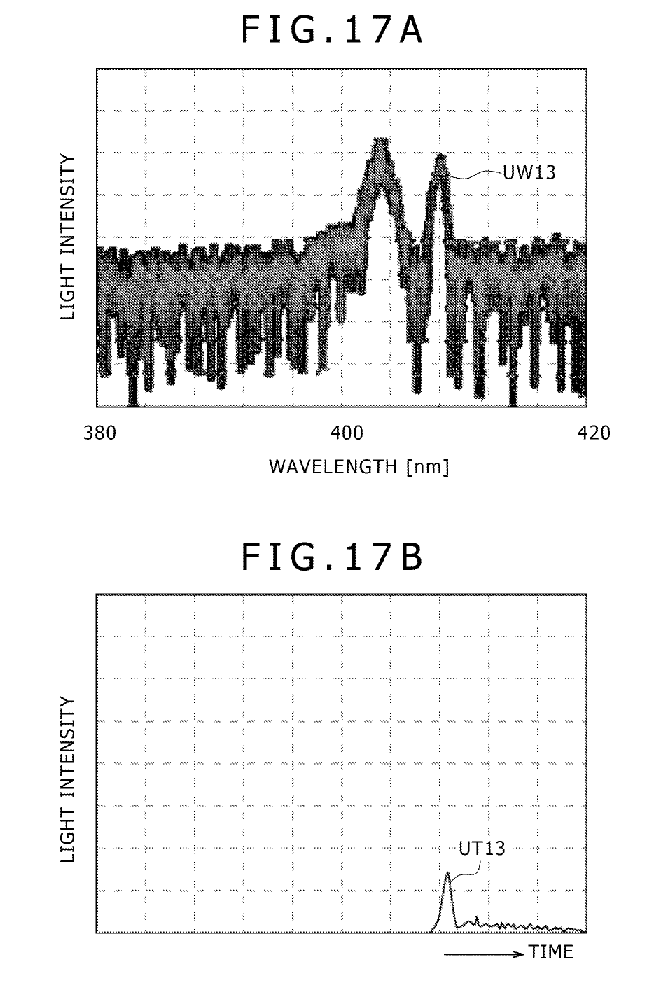

As shown in FIG. 17B, when the maximum voltage value Vmax of the driving pulse PD is 15.6 [V], a light intensity characteristic UT13 of the laser light LL has a first peak part and a gently attenuated slope part.

At this time, as shown in FIG. 17A, the wavelength characteristic UW13 has two peaks at wavelengths of about 404 [nm] and about 408 [nm]. In this wavelength characteristic UW13, the peak of about 406 [nm] observed in the relaxation oscillation mode is moved by 2 [nm] to a long wavelength side, and the region of 398 [nm] slightly rises.

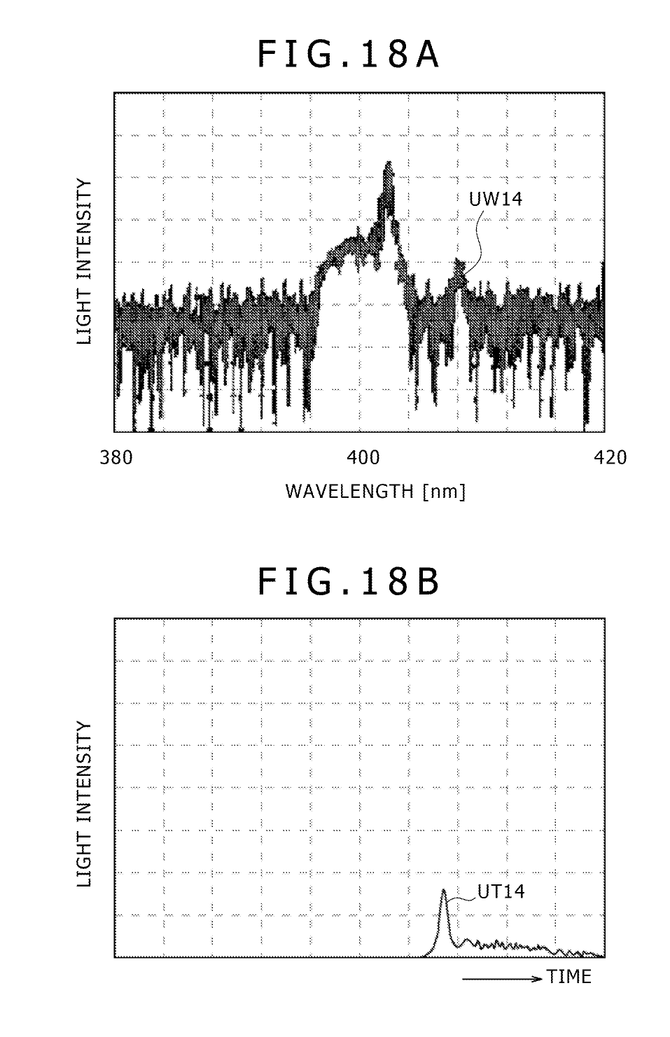

As shown in FIG. 18B, when the maximum voltage value Vmax of the driving pulse PD is 17.8 [V], a light intensity characteristic UT14 of the laser light LL has a first peak part and a gently attenuated slope part.

As shown in FIG. 18A, the wavelength characteristic UW14 at this time has two high peaks at wavelengths of about 398 [nm] and about 403 [nm]. In this wavelength characteristic UW14, the peak of about 408 [nm] is greatly lowered as compared with the wavelength characteristic UW13 (FIG. 17A), and instead a high peak is formed at about 398 [nm].

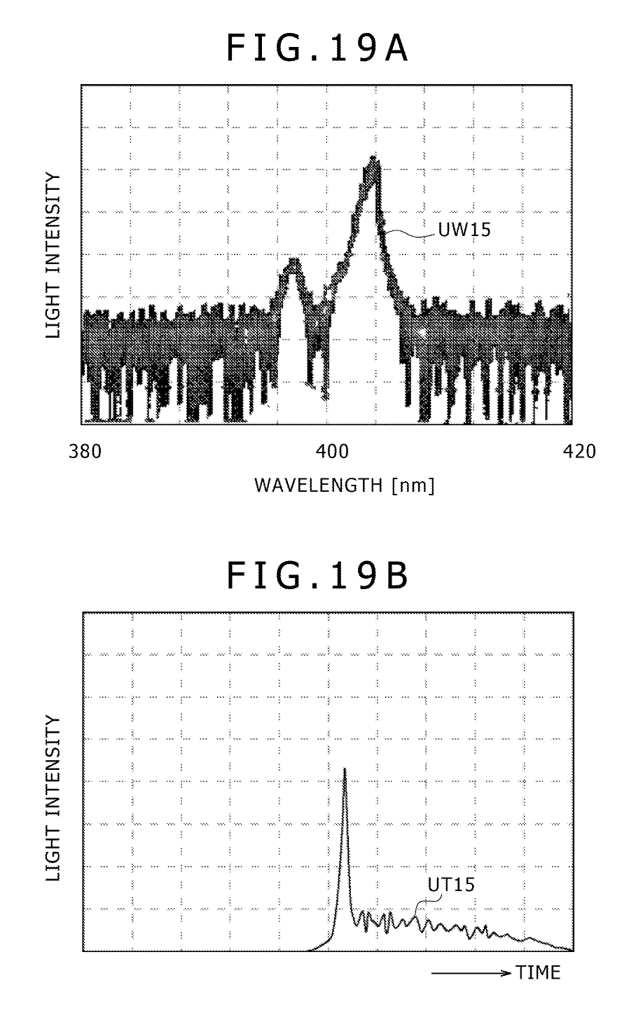

As shown in FIG. 19B, when the maximum voltage value Vmax of the driving pulse PD is 38.4 [V], a light intensity characteristic UT15 of the laser light LL has a first peak part and a gently attenuated slope part, which parts can be seen clearly.

In addition, as shown in FIG. 19A, the wavelength characteristic UW15 at this time has two peaks at wavelengths of about 398 [nm] and about 404 [nm]. In the wavelength characteristic UW15, the peak of about 408 [nm] disappears completely as compared with the wavelength characteristic UW14 (FIG. 18A), and a distinct peak is formed at about 398 [nm].

It has been confirmed from the above that the short pulse light source device 1 can output laser light LL whose waveform and wavelength are different from those of the oscillation output light LB by supplying the driving pulse PD of the singular voltage VE (that is, the maximum voltage value Vmax) higher than the oscillation voltage VB to the semiconductor laser 3. In addition, the emission start time τd of the laser light LL does not agree with Equation (3) derived from the above-described rate equation.

Attention will now be directed to the wavelength of the laser light LL. The laser light LL changes from ordinary output light LN (FIGS. 15A and 15B) to oscillation output light LB (FIGS. 16A and 16B) as the maximum voltage value Vmax is increased, and further changes the wavelength thereof from that of the oscillation output light LB.

Specifically, the oscillation output light LB (FIGS. 16A and 16B) in the wavelength characteristic UW12 has a peak of a wavelength substantially equal to that of the ordinary output light LN (within ±2 [nm] of the wavelength of the ordinary output light LN) and additionally has a peak shifted from the ordinary output light LN to a long wavelength side by about 3 [nm] (within 3±2 [nm]).

On the other hand, the laser light LL shown in FIGS. 19A and 19B in the wavelength characteristic UW15 has a peak of a wavelength substantially equal to that of the ordinary output light LN (within ±2 [nm] of the wavelength of the ordinary output light LN) and additionally has a peak shifted from the ordinary output light LN to a short wavelength side by about 6 [nm] (within 6±2 [nm]).

Accordingly, the laser light LL as shown in FIGS. 19A and 19B will hereinafter be referred to as singular output light LE, and an operation mode in which the short pulse light source device 1 outputs the singular output light LE from the semiconductor laser 3 will hereinafter be referred to as a singular mode.

### [1-3-4. Wavelength of Laser Light in Singular Mode]

A comparison of the wavelength characteristic UW14 (FIG. 18A) when the maximum voltage value Vmax is 17.8 [V] with the wavelength characteristic UW13 (FIG. 17A) when the maximum voltage value Vmax is 15.6 [V] shows that the peak on the long wavelength side disappears and that a peak on the short wavelength side appears instead.

That is, the wavelength characteristic UW indicates that the peak on the long wavelength side decreases gradually and the peak on the short wavelength side increases instead in a process of the laser light LL changing from oscillation output light LB to singular output light LE as the maximum voltage value Vmax rises.

Accordingly, the laser light LL whose peak area on the short wavelength side is equal to or more than a peak area on the long wavelength side in the wavelength characteristic UW will hereinafter be defined as singular output light LE, and the laser light LL whose peak area on the short wavelength side is less than a peak area on the long wavelength side in the wavelength characteristic UW will hereinafter be defined as oscillation output light LB.

Incidentally, when two peaks overlap each other as in FIG. 18A, a wavelength shifted from the wavelength of the ordinary output light LN to the short wavelength side by 6 [nm] is set as a center wavelength on the short wavelength side, and an area in a range of ±3 [nm] of the center wavelength is set as area of the peak.

Thus, according to this definition, the laser light LL when the maximum voltage value Vmax is 15.6 [V] (FIGS. 17A and 17B) is oscillation output light LB, and the laser light LL when the maximum voltage value Vmax is 17.8 [V] (FIGS. 18A and 18B) is singular output light LE.

Next, the short pulse light source device 1 was operated in the singular mode in the light measuring device 11, and a light intensity characteristic UT16 and a wavelength characteristic UW16 of a light beam LL (that is, singular output light LE) were measured. In addition, a light intensity characteristic UT17 and a wavelength characteristic UW17 were similarly measured in a state of the transmittance of wavelengths of 406±5 [nm] in the light beam LL being lowered by installing the BPF 13 in the light measuring device 11.

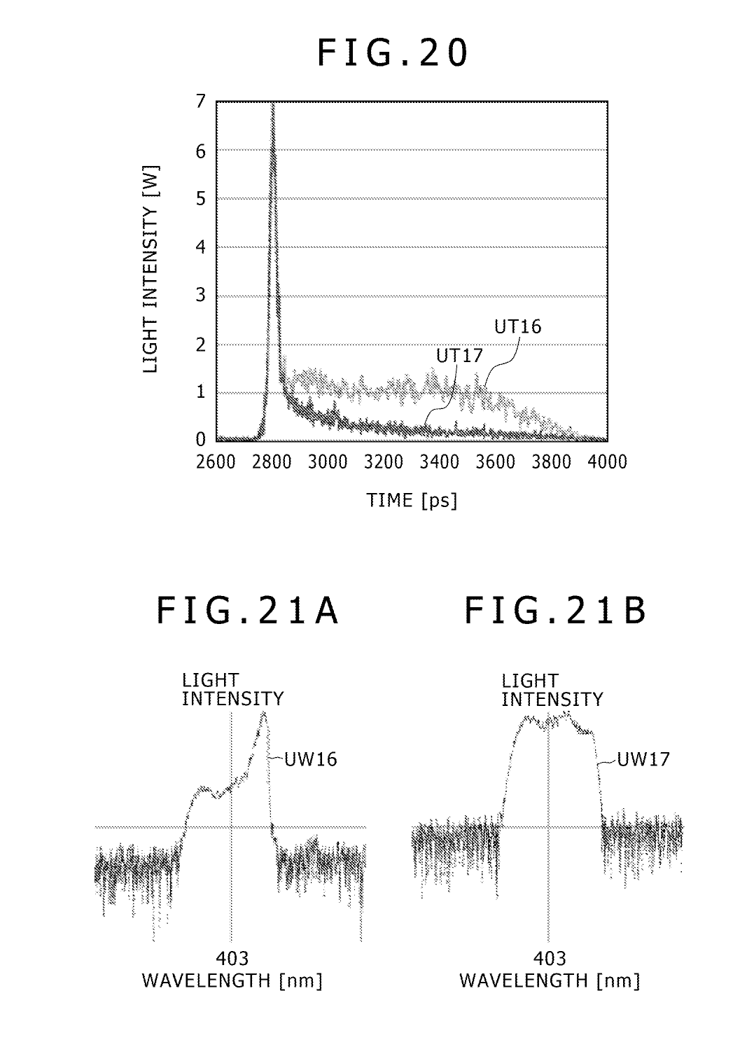

FIG. 20 shows the light intensity characteristic UT16 and the light intensity characteristic UT17 in an overlapping state. As is understood from FIG. 20, as compared with the light intensity characteristic UT16, the light intensity characteristic UT17 when the BPF 13 is installed has substantially equal light intensity at a peak part but has greatly decreased light intensity at a slope part.

This indicates that the light intensity of the slope part is decreased by the BPF 13 because the slope part has a wavelength of about 404 [nm], whereas the light intensity of the peak part is not decreased by the BPF 13 because the wavelength of the peak part is about 398 [nm].

FIGS. 21A and 21B show the wavelength characteristics UW16 and UW17, respectively. Incidentally, in FIGS. 21A and 21B, the wavelength characteristics UW16 and UW17 are each normalized according to a maximum light intensity, and light intensity on an axis of ordinates is relative values.

In the wavelength characteristic UW16 (FIG. 21A), the light intensity of a wavelength of 404 [nm] is higher than the light intensity of a wavelength of 398 [nm] so as to correspond to the slope part having a large area in the light intensity characteristic UT16.

On the other hand, in the wavelength characteristic UW17, the light intensity of a wavelength of 404 [nm] and the light intensity of a wavelength of 398 [nm] are substantially equal to each other as a result of the decrease of the slope part.

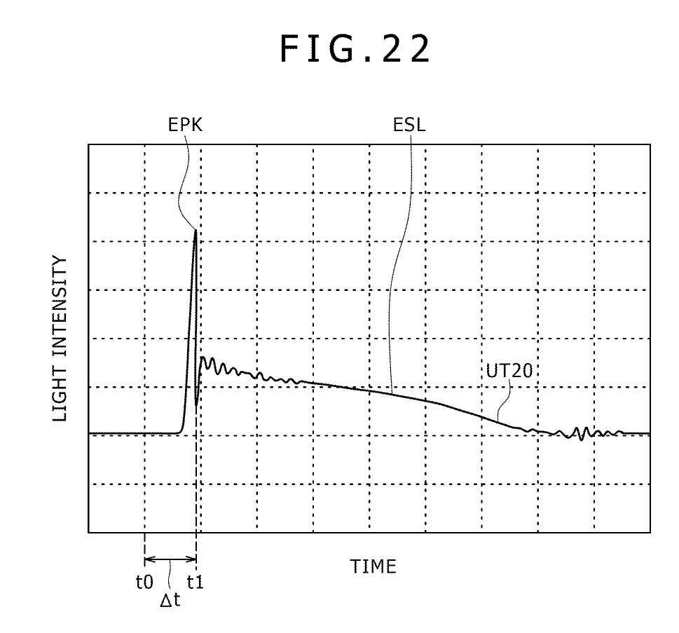

This also indicates that a singular slope ESL of the singular output light LE in a light intensity characteristic UT shown in FIG. 22 has a wavelength of about 404 [nm] and a singular peak EPK of the singular output light LE has a wavelength of about 398 [nm], that is, the wavelength of the peak part is shorter than the wavelength of the slope part.

In other words, the wavelength of the peak part in the light intensity characteristic UT of the singular output light LE is shifted to the short wavelength side by about 6 [nm] as compared with the ordinary output light LN. Incidentally, similar results were obtained when other semiconductor lasers whose ordinary output light LN had different wavelengths were used in other experiments.

A light intensity characteristic UT20 as shown in FIG. 22 was obtained when the light measuring device 11 measured singular output light LE using the SLD3233 manufactured by Sony Corporation as a semiconductor laser 3.

The light intensity of a peak part of the singular output light LE (which peak part will hereinafter be referred to as a singular peak EPK) was about 12 [W] when measured by the power meter 14. The light intensity of 12 [W] can be said to be a very high value as compared with the maximum light intensity (about 1 to 2 [W]) of the oscillation output light LB. Incidentally, this light intensity is not shown in FIG. 22 because of the low resolution of the light sample oscilloscope 16.

Further, a result of analysis by a streak camera (not shown) confirmed that the light intensity characteristic UT of the singular output light LE has a peak width of about 10 [ps] at the singular peak EPK, which peak width is reduced as compared with the peak width (about 30 [ps]) of the oscillation output light LB. Incidentally, this peak width is not shown in FIG. 22 because of the low resolution of the light sample oscilloscope 16.

On the other hand, a slope part in the light intensity characteristic UT of the singular output light LE (which slope part will hereinafter be referred to as a singular slope ESL) has a wavelength identical with the wavelength of laser light LL in the ordinary mode, and has a maximum light intensity of about 1 to 2 [W].

It suffices for the laser controlling section 2 (FIG. 1) to be able to generate the pulse signal SL of a pulse width of a few ten [ps] by the pulse signal generator 4, and to be able to amplify the peak voltage of the pulse signal SL to about 18 to 40 [V] by the driving circuit 6.

That is, the pulse signal generator 4 and the driving circuit 6 of the laser controlling section 2 can be realized by a relatively simple circuit configuration. Thus, the short pulse light source device 1 as a whole can be reduced in size as compared with ordinary picosecond lasers and femtosecond lasers.

The short pulse light source device 1 thus supplies the semiconductor laser 3 with the laser driving signal SD of the singular voltage VE even higher than the oscillation voltage VB. The short pulse light source device 1 can thereby emit such a singular output light LE as to make the singular peak EPK and the singular slope ESL sequentially appear in the light intensity characteristic UT from the semiconductor laser 3.

### 2. First Embodiment

### [2-1. Constitution of Optical Disk]

The constitution of an optical disk 100 will first be described. The optical disk 100 as a whole is formed substantially in the form of a disk, and has a plurality of layers such as a recording layer 100S and the like laminated in a direction of thickness of the optical disk 100.

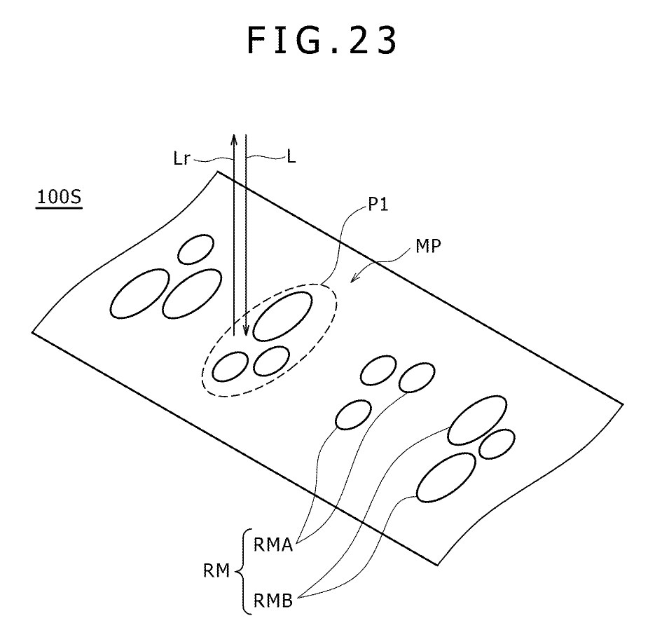

The recording layer 100S has a track formed in a spiral form. A recording mark group RM made by combining two kinds of recording marks RMA and RMB as shown in FIG. 23 is formed along the track. Incidentally, the recording marks RMA and RMB are physically formed by an electron beam lithography system or the like.

When a spot P1 is formed by irradiating the recording layer 100S with a light beam L of a predetermined wavelength, the recording layer 100S generates a return light beam Lr from a position irradiated with the spot P1, and lets the return light beam Lr travel in an opposite direction from the light beam L.

The recording mark group RM at this time enhances the light intensity of a specific wavelength band component in the return light beam Lr according to a local combination of recording marks RMA and RMB (which combination will hereinafter be referred to as a local mark MP) at the position irradiated with the spot P1 and the specific wavelength band component in the light beam L.

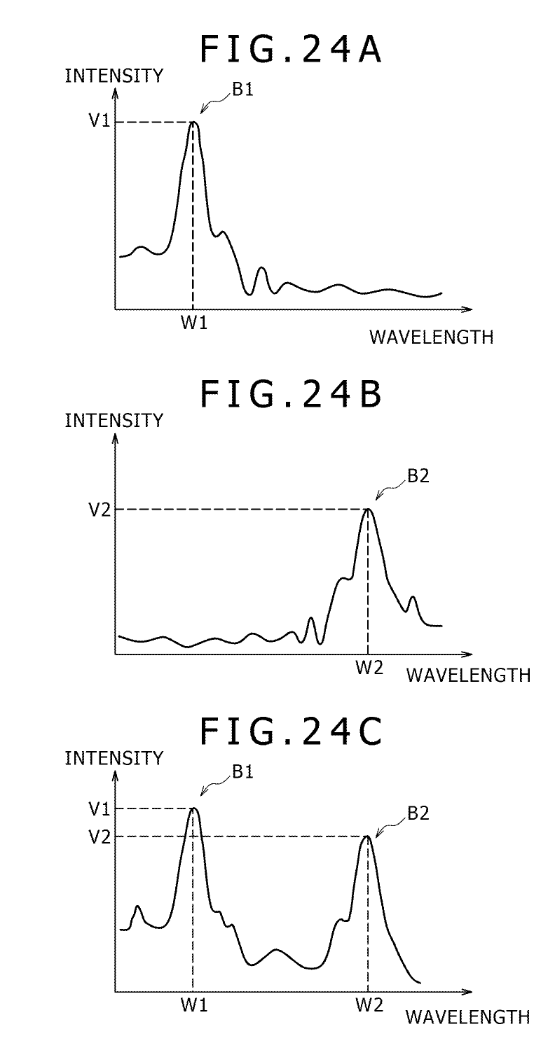

For example, when the light beam L includes a first wavelength band B1 having a predetermined first wavelength W1 as a center thereof, as shown in FIG. 24A, the return light beam Lr is changed in intensity of the first wavelength band B1 in a spectral curve (which intensity will hereinafter be referred to as first intensity V1) according to a local mark MP.

In addition, when the light beam L includes a second wavelength band B2 having a second wavelength W2 longer than the wavelength W1 as a center thereof, as shown in FIG. 24B, the return light beam Lr is changed in intensity of the second wavelength band B2 in the spectral curve (which intensity will hereinafter be referred to as second intensity V2) according to the local mark MP.

Further, when the light beam L includes both the first wavelength band B1 and the second wavelength band B2, as shown in FIG. 24C, the return light beam Lr is changed in each of the first intensity V1 and the second intensity V2 in the spectral curve according to the local mark MP.

When a ratio, arrangement and the like of the recording marks RMA and RMB of the local mark MP are set as appropriate, the local mark MP at this time can change the first intensity V1 and the second intensity V2 in the spectral curve of the return light beam Lr independently of each other.

Accordingly, in the recording layer 100S, codes indicating information to be stored on the optical disk 100 are divided into units of two bits, and two-bit codes are represented by respective local marks MP in the recording mark group RM.

Specifically, each local mark MP changes the first intensity V1 to a “low level” or a “high level” according to the value “0” or “1” of the lower-order bit of a two-bit code, and changes the second intensity V2 to a “low level” or a “high level” according to the value “0” or “1” of the higher-order bit of the two-bit code.

That is, the return light beam Lr obtained from the recording layer 100S has information of two bits multiplexed and modulated in each wavelength band.

Thus, because the recording mark group RM is formed in the recording layer 100S, the optical disk 100 changes the spectral characteristics of the return light beam Lr according to the wavelength bands included in the light beam L and the local mark MP.

### [2-2. Constitution of Optical Disk Reproducing Device]

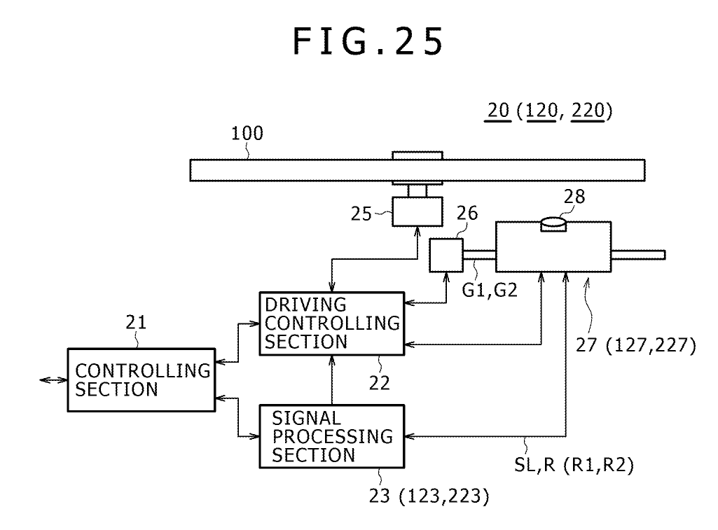

A first embodiment will next be described. An optical disk reproducing device 20 shown in FIG. 25 reproduces information from the recording layer 100S (FIG. 23) of the optical disk 100 using the above-described semiconductor laser 3.

The optical disk reproducing device 20 is formed centered on a controlling section 21. The controlling section 21 includes a CPU (Central Processing Unit), a ROM (Read Only Memory) storing various programs and the like, and a RAM (Random Access Memory) used as a work area of the CPU and the like, though the CPU, the ROM, and the RAM are not shown in FIG. 25.

When reproducing information from the optical disk 100, the controlling section 21 rotation-drives a spindle motor 25 via a driving controlling section 22, and thereby rotates the optical disk 100 mounted on a turntable (not shown) at a desired speed.

In addition, the controlling section 21 drives a sled motor 26 via the driving controlling section 22, and thereby greatly moves an optical pickup 27 in a tracking direction, that is, a direction of going toward an inner circumference side or an outer circumference side of the optical disk 100 along moving axes G1 and G2.

The optical pickup 27 incorporates a plurality of optical parts such as an objective lens 28, the semiconductor laser 3, and the like. The optical pickup 27 emits a light beam L formed of laser light LL from the semiconductor laser 3 under control of the controlling section 21, and irradiates the optical disk 100 with the light beam L.

In addition, the optical pickup 27 detects return light beam Lr returned from the recording layer 100S of the optical disk 100 in response to the light beam L, generates a plurality of detection signals R based on a result of the detection, and supplies these detection signals R to a signal processing section 23 (details will be described later).

The signal processing section 23 subjects the detection signals R to a predetermined demodulating process, a decoding process and the like, and thereby reconstructs information stored as a spot position mark in the recording layer 100S (details will be described later).

In addition, the signal processing section 23 generates a focus error signal and a tracking error signal by performing a predetermined operation process using the supplied detection signals R, and supplies the focus error signal and the tracking error signal to the driving controlling section 22.

The driving controlling section 22 performs focus control and tracking control on the objective lens 28 by driving the objective lens 28 by an actuator not shown in the figure on the basis of the focus error signal and the tracking error signal.

The driving controlling section 22 can thereby make the focus of the light beam L condensed by the objective lens 28 follow a desired track in the recording layer 100S of the optical disk 100.

The optical disk reproducing device 20 thus reproduces information from the recording layer 100S of the optical disk 100.

### [2-3. Constitution of Optical Pickup]

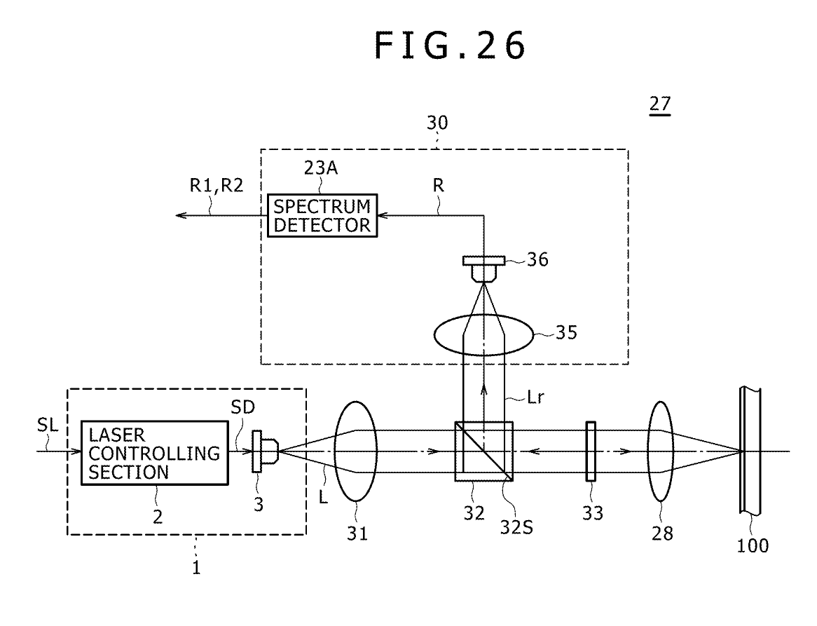

As shown in FIG. 26, the optical pickup 27 incorporates the laser controlling section 2 and the semiconductor laser 3 of the short pulse light source device 1 described above (FIG. 1).

As described above, the short pulse light source device 1 as a whole can be miniaturized as compared with ordinary picosecond lasers and femtosecond lasers. Therefore the optical pickup 27 and the optical disk reproducing device 20 having the optical pickup 27 can also be miniaturized as a whole as compared with ordinary picosecond lasers and femtosecond lasers.

The laser controlling section 2 is supplied with a pulse signal SL (FIG. 2A) from the signal processing section 23, generates a laser driving signal SD of a singular voltage VE, and supplies the laser driving signal SD to the semiconductor laser 3.

The semiconductor laser 3 outputs singular output light LE as light beam L, and makes the light beam L enter a collimator lens 31. Incidentally, the light beam L is formed of diverging light and is formed of linearly polarized light whose direction of polarization is that of p-polarized light.

The collimator lens 31 converts the light beam L from diverging light to collimated light, and then makes the light beam L enter a polarization beam splitter 32.

The polarization beam splitter 32 transmits substantially all of p-polarized light and reflects substantially all of s-polarized light at a polarization reflecting surface 32S. The polarization beam splitter 32 transmits substantially all of the light beam L formed of p-polarized light at the polarization reflecting surface 32S, and then makes the light beam L enter a quarter-wave plate 33.

The quarter-wave plate 33 interconverts light between linearly polarized light and circularly polarized light. The quarter-wave plate 33 converts the light beam L formed of p-polarized light into left circularly polarized light, and then makes the light beam L enter the objective lens 28. The objective lens 28 converges the light beam L and condenses the light beam L on the recording layer 100S of the optical disk 100.

At this time, as described above, the recording layer 100S generates a return light beam Lr according to a local mark MP at a position irradiated with the light beam L and wavelength bands included in the light beam L, and makes the return light beam Lr travel in an opposite direction from the light beam L. The return light beam Lr is right circularly polarized light opposite from the light beam L and is diverging light.

As light beam L, a singular peak EPK of a wavelength of about 398 [nm] and a singular slope ESL of a wavelength of about 404 [nm] (FIG. 22) appear sequentially. Thus, peak intensity VP and slope intensity VS in a spectral curve of the return light beam Lr are sequentially changed according to the local mark MP.

The return light beam Lr is converted from diverging light to collimated light by the objective lens 28, converted from right circularly polarized light to s-polarized light (linearly polarized light) by the quarter-wave plate 33, and then made to enter the polarization beam splitter 32 of a detection signal generating section 30.

The polarization beam splitter 32 reflects the return light beam Lr formed of s-polarized light at the polarization reflecting surface 32S, and makes the return light beam Lr enter a condensing lens 35 in the detection signal generating section 30.

The condensing lens 35 condenses the return light beam Lr, and irradiates a photodetector 36 with the condensed return light beam Lr. The photodetector 36 detects the light intensity of the return light beam Lr, generates a detection signal R according to the light intensity, and then supplies the detection signal R to a spectrum detector 23A of the signal processing section 23.

The spectrum detector 23A subjects the detection signal R to a spectrum analyzing process, and thereby obtains a spectrum characteristic curve as shown in FIG. 24C. Further, the spectrum detector 23A sets a first intensity V1 at a first wavelength W1 and a second intensity V2 at a second wavelength W2 as a first detection signal R1 and a second detection signal R2, respectively.

The first intensity V1 of the first detection signal R1 at this time represents the value “0” or “1” of a lower-order bit in a code stored in the local mark MP. The second intensity V2 of the second detection signal R2 at this time represents the value “0” or “1” of a higher-order bit in the code stored in the local mark MP.

The detection signal generating section 30 thus generates the first detection signal R1 and the second detection signal R2 by performing spectrum analysis of the detection signal R obtained on the basis of the return light beam Lr.

The signal processing section 23 extracts the lower-order bit and the higher-order bit in the code stored in the local mark MP on the basis of the first detection signal R1 and the second detection signal R2. The signal processing section 23 then reproduces information stored on the optical disk 100 by subjecting the extracted code to a predetermined decoding process and the like.

Thus, the optical pickup 27 condenses the light beam L emitted from the semiconductor laser 3 onto the local mark MP, whereby the return light beam Lr modulated at each of the first wavelength W1 and the second wavelength W2 by the information of the two bits is generated, and generates the detection signal R indicating the light intensity of the return light beam Lr.

Accordingly, the signal processing section 23 generates the first detection signal R1 and the second detection signal R2 and detects the first intensity V1 and the second intensity V2 at the first wavelength W1 and the second wavelength W2, respectively, by performing spectrum analysis of the detection signal R, and reproduces the information on the basis of the first detection signal R1 and the second detection signal R2.

### [2-4. Operation and Effects]

In the above constitution, the optical disk reproducing device 20 makes the light beam L of singular output light LE output by supplying the laser driving signal SD of singular voltage VE from the laser controlling section 2 incorporated in the optical pickup 27 to the semiconductor laser 3.

The optical pickup 27 condenses the light beam L by the objective lens 28, and irradiates the recording layer 100S of the optical disk 100 with the light beam L. At this time, the return light beam Lr modulated in each wavelength band by the information of two bits is generated by the local mark MP formed in the recording layer 100S.

The detection signal generating section 30 generates the detection signal R according to the light intensity of the return light beam Lr by the photodetector 36, and generates the first detection signal R1 and the second detection signal R2 indicating light intensity at the first wavelength W1 and the second wavelength W2, respectively, in the detection signal R by the spectrum detector 23A.

The signal processing section 23 recognizes the first intensity V1 and the second intensity V2 on the basis of the first detection signal R1 and the second detection signal R2, extracts the code stored in the local mark MP, and then reproduces the information.

Therefore the optical disk reproducing device 20 can output the singular output light LE including the singular peak EPK having a very short pulse width and a sufficient light intensity similar to those of ordinary picosecond lasers and femtosecond lasers as light beam L from the semiconductor laser 3.

Thus the optical disk reproducing device 20 can generate the return light beam Lr whose light intensity is modulated at each of the first wavelength W1 and the second wavelength W2 according to the local mark MP formed at a position irradiated with the light beam L.

The laser controlling section 2 of the short pulse light source device 1 incorporated in the optical pickup 27 in this case can be formed in a relatively small size, as described above. Thus the optical disk reproducing device 20 as a whole can also be formed in a very small size as compared with cases where ordinary picosecond lasers and femtosecond lasers are used.

At this time, it suffices for the optical disk reproducing device 20 only to supply the pulse signal SL from the signal processing section 23 to the laser controlling section 2. It is thus not necessary to perform complex light emission control or the like.

According to the above constitution, the optical disk reproducing device 20 emits the light beam L of singular output light LE from the semiconductor laser 3 incorporated in the optical pickup 27, and condenses the light beam L onto the local mark MP formed in the recording layer 100S of the optical disk 100. Thereby, the optical disk reproducing device 20 can generate the return light beam Lr modulated in each wavelength band by the information of two bits from the local mark MP, detect the first intensity V1 and the second intensity V2 by spectrum analysis, extract the code, and reproduce the information. Consequently, the optical disk reproducing device 20 can reproduce information modulated in each wavelength band with a relatively small constitution using the semiconductor laser 3 as in cases where ordinary picosecond lasers and femtosecond lasers are used.

### 3. Second Embodiment

### [3-1. Constitution of Optical Disk]

In a second embodiment, an optical disk 100 is formed in substantially the same manner as in the first embodiment, but is partly different in constitution of a recording mark group RM.

Specifically, recording marks RMA and RMB of the recording mark group RM are designed such that the first wavelength W1 of a return light beam Lr is about 398 [nm], which is equal to that of a singular peak EPK, and the second wavelength W2 of the return light beam Lr is about 404 [nm], which is equal to that of a singular slope ESL.

The return light beam Lr is thus changed in intensity of a first wavelength band B1 having a wavelength of about 398 [nm] as a center thereof in a spectral curve and in intensity of a second wavelength band B2 having a wavelength of about 404 [nm] as a center thereof in the spectral curve according to a pattern of formation of a local mark MP or the like.

### [3-2. Constitution of Optical Disk Reproducing Device and Optical Pickup]

An optical disk reproducing device 120 (FIG. 25) in the second embodiment is different from the optical disk reproducing device 20 in the first embodiment in that the optical disk reproducing device 120 is provided with a signal processing section 123 and an optical pickup 127 in place of the signal processing section 23 and the optical pickup 27.

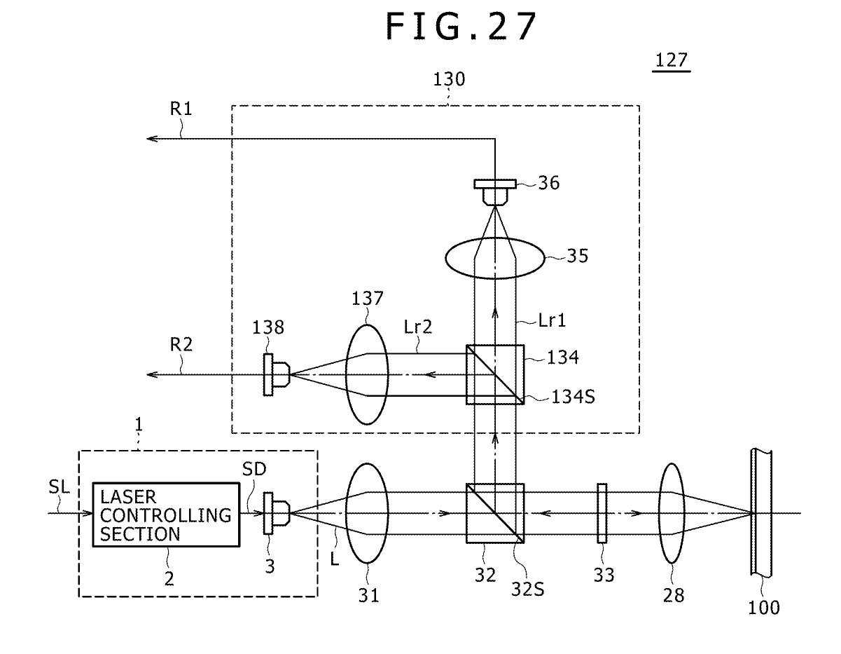

As shown in FIG. 27 in which parts corresponding to those of FIG. 26 are identified by the same reference numerals, the optical disk reproducing device 120 is provided with a detection signal generating section 130 in place of the detection signal generating section 30. In addition, the optical pickup 127 is different from the optical pickup 27 in that the optical pickup 127 has a wavelength selective mirror 134, a condensing lens 137, and a photodetector 138, though the optical pickup 127 is otherwise formed in a similar manner to that of the optical pickup 27.

As described above, as light beam L emitted from a semiconductor laser 3, a singular peak EPK of a wavelength of about 398 [nm] and a singular slope ESL of a wavelength of about 404 [nm] (FIG. 22) appear sequentially.

Thus, when the local mark MP is first irradiated with a light beam formed by a singular peak EPK (which light beam will hereinafter be referred to as a singular peak light beam LEP), the return light beam Lr is changed in first intensity V1 of the first wavelength W1, which is a wavelength of about 398 [nm], as shown in FIG. 24A.

Then, when the local mark MP is irradiated with a light beam formed by a singular slope ESL (which light beam will hereinafter be referred to as a singular slope light beam LES), the return light beam Lr is changed in second intensity V2 of the second wavelength W2, which is a wavelength of about 404 [nm], as shown in FIG. 24B. Thus, in the second embodiment, the first intensity

V1 and the second intensity V2, which are light intensities at the respective wavelengths of the singular peak light beam LEP and the singular slope light beam LES of the light beam L, are each changed so as to correspond to the different wavelengths of the singular peak light beam LEP and the singular slope light beam LES of the light beam L.

The return light beam Lr is reflected by the polarization reflecting surface 32S of a polarization beam splitter 32, and made to enter the wavelength selective mirror 134 of the detection signal generating section 130.

The wavelength selective mirror 134 transmits substantially all of light having wavelengths less than 401 [nm] and reflects substantially all of light having wavelengths equal to or more than the wavelength of 401 [nm] at a mirror surface 1345 having wavelength selectivity.

Thus, the wavelength selective mirror 134 transmits a component of less than the wavelength of 401 [nm] which component is included in the return light beam Lr, sets the transmitted component as a first return light beam Lr1, and makes the first return light beam Lr1 enter a condensing lens 35. In addition, the wavelength selective mirror 134 reflects a component of the wavelength of 401 [nm] and more which component is included in the return light beam Lr, sets the reflected component as a second return light beam Lr2, and makes the second return light beam Lr2 enter the condensing lens 137.

The condensing lens 35 condenses the first return light beam Lr1, and irradiates a photodetector 36 with the first return light beam Lr1. The photodetector 36 detects the light intensity of the first return light beam Lr1, generates a first detection signal R1 having a signal level corresponding to the light intensity of the first return light beam Lr1, and sends the first detection signal R1 to the signal processing section 123 (FIG. 25).

At this time, the magnitude of the first intensity V1 is dominant in the first detection signal R1 due to the singular peak light beam LEP of the wavelength of about 398 [nm] in the light beam L, and the first detection signal R1 has a signal level corresponding to the magnitude of the first intensity V1.

Thus, the signal level of the first detection signal R1 represents the value “0” or “1” of a lower-order bit in a code of two bits stored in the local mark MP.

Meanwhile, the condensing lens 137 condenses the second return light beam Lr2, and irradiates the photodetector 138 with the second return light beam Lr2. The photodetector 138 detects the light intensity of the second return light beam Lr2, generates a second detection signal R2 having a signal level corresponding to the light intensity of the second return light beam Lr2, and sends the second detection signal R2 to the signal processing section 123 (FIG. 25).

At this time, the magnitude of the second intensity V2 is dominant in the second detection signal R2 due to the singular slope light beam LES of the wavelength of about 404 [nm] in the light beam L, and the second detection signal R2 has a signal level corresponding to the magnitude of the second intensity V2.

Thus, the signal level of the second detection signal R2 represents the value “0” or “1” of a higher-order bit in the code of two bits stored in the local mark MP.

Thus, the detection signal generating section 130 separates the return light beam Lr obtained from the local mark MP into the first return light beam Lr1 and the second return light beam Lr2, and then generates the first detection signal R1 and the second detection signal R2 indicating the respective light intensities of the first return light beam Lr1 and the second return light beam Lr2.

The signal processing section 123 (FIG. 25) accordingly subjects the first detection signal R1 and the second detection signal R2 to a predetermined demodulating process or the like, and thereby extracts each of the lower-order bit and the higher-order bit in the code stored in the local mark MP.

The signal processing section 123 further subjects the extracted code to a predetermined decoding process or the like, and thereby reproduces information stored on the optical disk 100.

### [3-3. Operation and Effects]

In the above constitution, the optical disk reproducing device 120 according to the second embodiment outputs the light beam L of singular output light LE from the semiconductor laser 3 incorporated in the optical pickup 127. The optical pickup 127 irradiates the local mark MP formed in the recording layer 100S of the optical disk 100 with the light beam L.

At this time, the local mark MP changes the first intensity V1 at the wavelength of about 398 [nm] when irradiated with the singular peak light beam LEP, and changes the second intensity V2 at the wavelength of about 404 [nm] when irradiated with the singular slope light beam LES.

The detection signal generating section 130 separates the return light beam Lr into the first return light beam Lr1 and the second return light beam Lr2 by the wavelength selective mirror 134, detects the respective light intensities of the first return light beam Lr1 and the second return light beam Lr2 by the photodetectors 36 and 138, and generates the first detection signal R1 and the second detection signal R2.

The signal processing section 123 subjects each of the first detection signal R1 and the second detection signal R2 to a predetermined demodulating process or the like, thereby extracts the lower-order bit and the higher-order bit in the code stored in the local mark MP, and reproduces information.

Thus, as in the first embodiment, the optical disk reproducing device 120 can output the singular output light LE as light beam L from the semiconductor laser 3. The optical disk reproducing device 120 can therefore be greatly miniaturized as compared with cases where ordinary picosecond lasers and femtosecond lasers are used.

Further, in the second embodiment, the local mark MP formed in the optical disk 100 is designed so as to correspond to the wavelengths of the singular peak light beam LEP and the singular slope light beam LES.

Thus, the optical pickup 127 first irradiates the local mark MP with the singular peak light beam LEP including the first wavelength W1, the singular peak light beam LEP being included in the light beam L formed of singular output light LE. Thereby the first intensity V1 of the first wavelength W1 in the return light beam Lr can be changed.

Next, the optical pickup 127 irradiates the local mark MP with the singular slope light beam LES including the second wavelength W2. Thereby the second intensity V2 of the second wavelength W2 in the return light beam Lr can be changed.

Thus, the optical pickup 127 can separate the return light beam Lr into the first return light beam Lr1 in which the first intensity V1 appears and the second return light beam Lr2 in which the second intensity V2 appears by the wavelength selective mirror 134.

Thereby, the photodetector 36 can generate the first detection signal R1 in which the first intensity V1 appears and from which a component of the second wavelength W2 is eliminated, by merely detecting the light intensity of the first return light beam Lr1. In addition, the photodetector 138 can generate the second detection signal R2 in which the second intensity V2 appears and from which a component of the first wavelength W1 is eliminated, by merely detecting the light intensity of the second return light beam Lr2.

The second embodiment can therefore generate the first detection signal R1 and the second detection signal R2 independently of each other by ordinary photodetectors without using a high-performance processing circuit such as the spectrum detector 23A for performing advanced operation processing such as a fast Fourier transform.

The optical disk reproducing device 120 can produce similar effects to those of the first embodiment in other respects.

According to the above constitution, the optical disk reproducing device 120 emits the light beam L of singular output light LE from the semiconductor laser 3 incorporated in the optical pickup 127, and condenses the light beam L onto the local mark MP formed in the recording layer 100S of the optical disk 100. At this time, the optical disk reproducing device 120 generates, from the local mark MP, the return light beam Lr in which the first intensity V1 at the first wavelength W1 and the second intensity V2 at the second wavelength W2 are sequentially changed in response to the singular output light LE, and separates the return light beam Lr into the first return light beam Lr1 and the second return light beam Lr2. Further, the optical disk reproducing device 120 detects each of the light intensities of the first return light beam Lr1 and the second return light beam Lr2, and generates the first detection signal R1 and the second detection signal R2. Thereby the optical disk reproducing device 120 extracts the code stored in the local mark MP and reproduces information. Consequently, the optical disk reproducing device 120 can reproduce information from the optical disk 100 with a relatively small and simple constitution.

### 4. Third Embodiment

The constitution of an optical disk 100 in a third embodiment is the same as in the second embodiment, and therefore description thereof will be omitted.

### [4-1. Constitution of Optical Disk Reproducing Device and Optical Pickup]

An optical disk reproducing device 220 (FIG. 25) in the third embodiment is different from the optical disk reproducing device 20 in the first embodiment in that the optical disk reproducing device 220 is provided with a signal processing section 223 and an optical pickup 227 in place of the signal processing section 23 and the optical pickup 27.

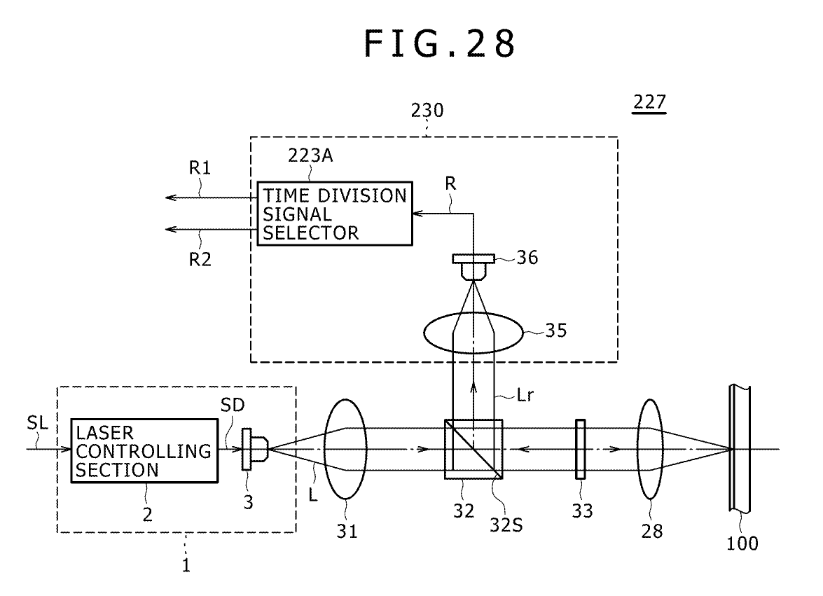

As shown in FIG. 28 in which parts corresponding to those of FIG. 26 and FIG. 27 are identified by the same reference numerals, the optical disk reproducing device 220 is provided with a detection signal generating section 230 in place of the detection signal generating section 30. In addition, the detection signal generating section 230 is different from the detection signal generating section 30 in that the detection signal generating section 230 has a time division signal selector 223A in place of the spectrum detector 23A. However, the detection signal generating section 230 is otherwise formed in a similar manner to that of the detection signal generating section 30.

As described above, as light beam L emitted from a semiconductor laser 3, a singular peak EPK of a wavelength of about 398 [nm] and a singular slope ESL of a wavelength of about 404 [nm] (FIG. 22) appear sequentially.

Thus, as in the second embodiment, when a local mark MP is first irradiated with a singular peak light beam LEP, a return light beam Lr is changed in first intensity V1 of a first wavelength W1, which is the wavelength of about 398 [nm], as shown in FIG. 24A.

Then, when the local mark MP is irradiated with a singular slope light beam LES, the return light beam Lr is changed in second intensity V2 of a second wavelength W2, which is the wavelength of about 404 [nm], as shown in FIG. 24B.

That is, the return light beam Lr is sequentially changed in the first intensity V1 and the second intensity V2, which are light intensities at the respective wavelengths of the singular peak EPK and the singular slope ESL (FIG. 22), so as to correspond to sequential appearance of the singular peak EPK and the singular slope ESL of different wavelengths in the light beam L.

The return light beam Lr is reflected by the polarization reflecting surface 32S of a polarization beam splitter 32, condensed by a condensing lens 35, and applied to a photodetector 36. The photodetector 36 detects the light intensity of the return light beam Lr, generates a detection signal R corresponding to the light intensity of the return light beam Lr, and supplies the detection signal R to the time division signal selector 223A of the detection signal generating section 230.

The time division signal selector 223A outputs the detection signal R as a first detection signal R1 as it is for a period from time point to, at which a pulse signal SL is supplied to a laser controlling section 2, to a predetermined time point t1. The time division signal selector 223A outputs the detection signal R as a second detection signal R2 as it is after time point t1.

In this case, the first detection signal R1 has a signal level corresponding to the magnitude of the first intensity V1 resulting from the singular peak light beam LEP of the wavelength of about 398 [nm] in the light beam L. Therefore the signal level of the first detection signal R1 represents the value “0” or “1” of a lower-order bit in a code of two bits stored in the local mark MP.

The second detection signal R2 has a signal level corresponding to the magnitude of the second intensity V2 resulting from the singular slope light beam LES of the wavelength of about 404 [nm] in the light beam L. Therefore the signal level of the second detection signal R2 represents the value “0” or “1” of a higher-order bit in the code of two bits stored in the local mark MP.

Incidentally, a period At from time point t0 to time point t1 is determined on the basis of the light emission characteristic of the semiconductor laser 3, the length of an optical path in the optical pickup 227, the response characteristic of the photodetector 36, and the like. This period At roughly corresponds to a time obtained by adding together the time width of the singular peak EPK and various delay times.

Thus, the detection signal generating section 230 separates the detection signal R into the first detection signal R1 and the second detection signal R2 by temporally dividing the return light beam Lr obtained from the local mark MP.

Next, the signal processing section 223 subjects the first detection signal R1 and the second detection signal R2 to a predetermined demodulating process or the like, and thereby extracts each of the lower-order bit and the higher-order bit in the code stored in the local mark MP.

The signal processing section 223 further subjects the extracted code to a predetermined decoding process or the like, and thereby reproduces information stored on the optical disk 100.

### [4-2. Operation and Effects]

In the above constitution, the optical disk reproducing device 220 according to the third embodiment outputs the light beam L of singular output light LE from the semiconductor laser 3 incorporated in the optical pickup 227. The optical pickup 227 irradiates the local mark MP formed in the recording layer 100S of the optical disk 100 with the light beam L.

At this time, the local mark MP changes the first intensity V1 at the wavelength of about 398 [nm] when irradiated with the singular peak light beam LEP, and changes the second intensity V2 at the wavelength of about 404 [nm] when irradiated with the singular slope light beam LES.

The optical pickup 227 detects the light intensity of the return light beam Lr by the photodetector 36, and generates the detection signal R. The detection signal generating section 230 divides the detection signal R into the first detection signal R1 corresponding to the singular peak EPK and the second detection signal R2 corresponding to the singular slope ESL by the time division signal selector 223A.

Thereafter, the signal processing section 223 extracts the lower-order bit and the higher-order bit in the code stored in the local mark MP independently of each other on the basis of the first detection signal R1 and the second detection signal R2, and reproduces information.

Thus, as in the first and second embodiments, the optical disk reproducing device 220 can output the singular output light LE as light beam L from the semiconductor laser 3. The optical disk reproducing device 220 can therefore be greatly miniaturized as compared with cases where ordinary picosecond lasers and femtosecond lasers are used.

Further, in the third embodiment, as in the second embodiment, the local mark MP formed in the optical disk 100 is designed so as to correspond to the wavelengths of the singular peak light beam LEP and the singular slope light beam LES.

Thus, the optical pickup 227 first irradiates the local mark MP with the singular peak light beam LEP including the first wavelength W1, the singular peak light beam LEP being included in the light beam L formed of singular output light LE. Thereby the first intensity V1 of the first wavelength W1 in the return light beam Lr can be changed.

Next, the optical pickup 227 irradiates the local mark MP with the singular slope light beam LES including the second wavelength W2. Thereby the second intensity V2 of the second wavelength W2 in the return light beam Lr can be changed.

Utilizing such properties of the light beam L and the return light beam Lr, the time division signal selector 223A can separate the detection signal R into the first detection signal R1 in which the first intensity V1 appears and the second detection signal R2 in which the second intensity V2 appears by merely temporally dividing the detection signal R.

At this time, it suffices for the signal processing section 223 only to change a position to which the detection signal R is output by the time division signal selector 223A after the passage of the predetermined period At from time point t0 at which the signal processing section 223 itself supplied the pulse signal SL to the laser controlling section 2. It is not necessary to perform a complex signal synchronizing process or the like.

The optical disk reproducing device 220 can produce similar effects to those of the first and second embodiments in other respects.

According to the above constitution, the optical disk reproducing device 220 emits the light beam L of singular output light LE from the semiconductor laser 3 incorporated in the optical pickup 227, and condenses the light beam L onto the local mark MP formed in the recording layer 100S of the optical disk 100. At this time, the optical disk reproducing device 220 generates, from the local mark MP, the return light beam Lr in which the first intensity V1 at the first wavelength W1 and the second intensity V2 at the second wavelength W2 are sequentially changed in response to the singular output light LE, detects the light intensity of the return light beam Lr, and generates the detection signal R. Further, the optical disk reproducing device 220 separates the detection signal R into the first detection signal R1 and the second detection signal R2 at time point t1, and recognizes the first intensity V1 and the second intensity V2 independently of each other on the basis of the first detection signal R1 and the second detection signal R2. The optical disk reproducing device 220 thereby extracts the code stored in the local mark MP, and reproduces information. Consequently, the optical disk reproducing device 220 can reproduce information from the optical disk 100 with a relatively small and simple constitution.

### 5. Other Embodiments

Incidentally, in the foregoing first embodiment, description has been made of a case where the detection signal generating section 30 generates the first detection signal R1 and the second detection signal R2 indicating the first intensity V1 of the first wavelength W1 and the second intensity V2 of the second wavelength W2, respectively, by spectrum analysis. In addition, in the second embodiment, description has been made of a case where the detection signal generating section 130 separates the return light beam Lr into the first return light beam Lr1 and the second return light beam Lr2 according to wavelength and then generates each of the first detection signal R1 and the second detection signal R2. Further, in the third embodiment, description has been made of a case where the detection signal generating section 230 separates the detection signal R into the first detection signal R1 and the second detection signal R2 at time point t1.

The present invention is not limited to this. Various methods may be used which for example separate or divide the return light beam Lr or analyze the detection signal R in a detection signal generating section. In this case, it suffices for the detection signal generating section to be able to generate each of the first detection signal R1 in which the first intensity V1 at the first wavelength W1 appears and the second detection signal R2 in which the second intensity V2 at the second wavelength W2 appears on the basis of the return light beam Lr.

In the foregoing first embodiment, description has been made of a case where the local mark MP is formed such that a peak appears at two positions of the first wavelength W1 and the second wavelength W2 on the spectral curve of the return light beam Lr, and a code is extracted on the basis of the first intensity V1 of the first wavelength W1 and the second intensity V2 of the second wavelength W2.

The present invention is not limited to this. For example, three or more peaks may be made to appear on the spectral curve of the return light beam Lr by increasing kinds of recording marks RM in a recording mark group RM, and a code may be extracted on the basis of the respective light intensities of the peaks. In this case, an amount of information that can be stored on the optical disk 100 can be increased.

In the foregoing second embodiment, description has been made of a case where the local mark MP is formed so as to change light intensities at the wavelengths of about 398 [nm] and about 404 [nm] on the spectral curve of the return light beam Lr according to the singular peak EPK and the singular slope ESL of the singular output light LE emitted from the semiconductor laser 3.

The present invention is not limited to this. When the singular peak EPK and the singular slope ESL of the singular output light LE emitted from the semiconductor laser 3 are of other wavelengths, the local mark MP may be formed so as to change light intensities at the other wavelengths on the spectral curve of the return light beam Lr. The same is true for the third embodiment.

Incidentally, in the case of the second embodiment, it suffices to adjust wavelength characteristics as appropriate such that the return light beam Lr can be separated into a part including the wavelength of the singular peak EPK and a part including the wavelength of the singular slope ESL by the mirror surface 134S of the wavelength selective mirror 134.

In the foregoing third embodiment, description has been made of a case where the time division signal selector 223A changes the position to which the detection signal R is output at time point t1 after the passage of the period At from time point t0 at which the pulse signal SL is supplied to the laser controlling section 2.

The present invention is not limited to this. The position to which the detection signal R is output may be changed at a time when an appropriately set period At from various time points has passed. Further, for example, the position to which the detection signal R is output may be changed at a time point when a peak corresponding to the singular peak EPK is detected in the detection signal R while the signal level of the detection signal R is checked. In the foregoing first embodiment, description has been made of a case where an ordinary semiconductor laser (SLD3233 manufactured by Sony Corporation or the like) is used as the semiconductor laser 3. However, the present invention is not limited to this. In short, it suffices for the semiconductor laser 3 to be a so-called semiconductor laser performing laser oscillation using a p-type semiconductor and an n-type semiconductor. It is more desirable to purposefully use a semiconductor laser formed so as to tend to perform large relaxation oscillation. The same is true for the second embodiment and the third embodiment.

In the foregoing embodiments, description has been made of a case where the recording marks RMA and RMB have a physical shape. The present invention is not limited to this. The recording marks RMA and RMB may be formed by locally changing optical reflectance or an index of refraction or effecting phase change, for example. In short, it suffices to generate return light beam Lr in response to a light beam L.

The shape of recording marks RM may be not only a circular shape in a plane as shown in FIG. 23 but also various other shapes. Alternatively, recording marks RM may be arranged one-dimensionally as in a bar code.

In the foregoing embodiment, description has been made of a case where the optical disk reproducing device 20 as an optical disk reproducing device is formed by the semiconductor laser 3 as a semiconductor laser, the objective lens 28 as an objective lens, the detection signal generating section 30 as a detection signal generating section, and the signal processing section 23 as a reproduction processing section.

However, the present invention is not limited to this. Optical disk reproducing devices may be formed by semiconductor lasers, objective lenses, detection signal generating sections, and reproduction processing sections having various other constitutions.

The present invention is also applicable to for example optical information recording and reproducing devices that record or reproduce a high volume of information such as video contents, audio contents or the like on a recording medium such as an optical disk or the like.

The present application contains subject matter related to that disclosed in Japanese Priority Patent Application JP 2009-006930 filed in the Japan Patent Office on Jan. 15, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical disk reproducing device comprising:
a semiconductor laser for sequentially emitting singular peak light having a light intensity characteristic in a form of a pulse and having a singular peak wavelength and singular slope light having a light intensity characteristic in a form of a slope of lower light intensity than said singular peak light and having a singular slope wavelength different from said singular peak wavelength as laser light when supplied with a driving pulse formed in a form of a pulse and formed of a predetermined singular voltage;
an objective lens for condensing said laser light onto a recording layer disposed in an optical disk, a plurality of kinds of recording marks being formed in the recording layer, and converting an angle of divergence of return light, the return light having a light intensity modulated in each of a plurality of wavelength bands independently and being returned from said recording layer;
a detection signal generating section configured to detect respective light intensities in each of said wavelength bands in said return light, and respectively generate a plurality of detection signals according to the respective light intensities; and
a reproduction processing section configured to reproduce information recorded on said optical disk on a basis of said plurality of detection signals.

2. The optical disk reproducing device according to claim 1,
wherein said detection signal generating section generates a first detection signal and a second detection signal according to the respective light intensities by detecting each of light intensity of a component of said singular peak wavelength and light intensity of a component of said singular slope wavelength in said return light, and
said reproduction processing section reproduces the information recorded on said optical disk on a basis of said first detection signal and said second detection signal.

3. The optical disk reproducing device according to claim 2,
wherein said detection signal generating section includes:
a light separating section configured to separate said return light into at least the component of said singular peak wavelength and the component of said singular slope wavelength;
a singular peak light receiving section configured to receive the component of said singular peak wavelength, the component of said singular peak wavelength being separated from said return light by said light separating section, and generate said first detection signal; and
a singular slope light receiving section configured to receive the component of said singular slope wavelength, the component of said singular slope wavelength being separated from said return light by said light separating section, and generate said second detection signal.

4. The optical disk reproducing device according to claim 3,
wherein said light separating section of said detection signal generating section is formed by a wavelength selective mirror transmitting one of the component of said singular peak wavelength and the component of said singular slope wavelength of said return light and reflecting the other.

5. The optical disk reproducing device according to claim 2,
wherein said detection signal generating section includes:
a light receiving section configured to sequentially receive the component of said singular peak wavelength and the component of said singular slope wavelength, the component of said singular peak wavelength and the component of said singular slope wavelength being included in said return light, and generate a detection signal according to light intensity of the component of said singular peak wavelength and the component of said singular slope wavelength; and
a signal dividing section configured to generate each of said first detection signal and said second detection signal by dividing said detection signal at a predetermined time point.

6. The optical disk reproducing device according to claim 5,
wherein said signal dividing section divides said detection signal into said first detection signal and said second detection signal according to timing in which said laser light emitted from said semiconductor laser changes from said singular peak light to said singular slope light.

7. The optical disk reproducing device according to claim 5,
wherein said signal dividing section divides said detection signal into said first detection signal and said second detection signal at a time point at which a predetermined division time from a time point of supply of said driving pulse to said semiconductor laser has passed.

8. An optical disk reproducing method comprising the steps of:
sequentially emitting singular peak light having a light intensity characteristic in a form of a pulse and having a singular peak wavelength and singular slope light having a light intensity characteristic in a form of a slope of lower light intensity than said singular peak light and having a singular slope wavelength different from said singular peak wavelength as laser light from a predetermined semiconductor laser when the semiconductor laser is supplied with a driving pulse formed in a form of a pulse and formed of a predetermined singular voltage;
condensing said laser light onto a recording layer disposed in an optical disk, a plurality of kinds of recording marks being formed in the recording layer, by a predetermined objective lens;
converting an angle of divergence of return light by said objective lens, the return light including a plurality of wavelengths, having a light intensity modulated at each of said wavelengths independently, and being returned from said recording layer;
detecting respective light intensities at each of said wavelengths in said return light, and respectively generating a plurality of detection signals according to the respective light intensities; and
reproducing information recorded on said optical disk on a basis of said plurality of detection signals.
